(19) United States
(12) Patent Application Publication
(10) Pub. No.: US 2022/0292597 A1
(43) Pub. Date: Sep. 15, 2022

(54) SYSTEM AND METHOD FOR VALUATION OF COMPLEX ASSETS

(71) Applicant: BLUE WATER FINANCIAL TECHNOLOGIES, LLC, St. Louis Park, MN (US)

(72) Inventors: Alan Pervez Qureshi, Excelsior, MN (US); Josh Freivogel, San Francisco, CA (US); Travis LaMar, Shoreview, MN (US); Ritchie Paul, Hopkins, MN (US); Yuvraj Shivtare, St. Louis Park, MN (US); Steve Dinger, Durham, NC (US)

(21) Appl. No.: 17/829,868

(22) Filed: Jun. 1, 2022

Related U.S. Application Data
(63) Continuation-in-part of application No. 17/063,856, filed on Oct. 6, 2020.
(60) Provisional application No. 62/911,735, filed on Oct. 7, 2019.

(51) Int. Cl. G06Q 40/02; G06Q 40/06; G06N 20/00

(52) U.S. Cl. CPC G06Q 40/025; G06Q 40/06; G06N 20/00

(57) ABSTRACT

A system is disclosed. The system has a mortgage servicing and loan valuation module, comprising computer-executable code stored in non-volatile memory, a processor, and a user interface configured to communicate with the mortgage servicing and loan valuation module and the processor. The mortgage servicing and loan valuation module, the processor, and the user interface are configured to receive a full loan valuation data of a buyer, select a plurality of loan samples based on the full loan valuation data, determine a function data file based on the full loan valuation data and the plurality of loan samples using machine learning operations, transform a seller asset data of a seller, which includes a plurality of assets, to a normalized data structure, and determine a subset of the plurality of assets by applying the function data file to the normalized data structure.

### CROSS-REFERENCE TO RELATED APPLICATIONS

This application claims priority to U.S. nonprovisional patent application Ser. No. 17/063,856 filed on Oct. 6, 2020, and entitled “AUTOMATED REAL TIME MORTGAGE SERVICING AND WHOLE LOAN VALUATION,” and U.S. provisional patent application 62/911,735 filed on Oct. 7, 2019, and entitled “AUTOMATED REAL TIME MORTGAGE SERVICING AND WHOLE LOAN VALUATION,” the entire disclosure of each of which is incorporated herein by reference.

### TECHNICAL FIELD

The present disclosure is directed to a system and method for mortgage servicing, and more particularly, to a system and method for automated real time mortgage servicing and whole loan valuation.

### BACKGROUND OF THE DISCLOSURE

Conventional industry practice for pricing of assets traded in the secondary market for mortgages typically involves market participants specifying static parameters to make pricing adjustments based on a relatively limited number of loan features, which are calculated against benchmark prices set relatively infrequently (e.g., usually at the beginning of the day). Using these conventional methods, buyers and sellers then typically transact loans at materially different prices than what their accounting methods assume based on the prevailing market prices at the time of the transaction and additional loan feature information.

Approaches to solving for this discrepancy have not been proffered due to the high dimensionality of the problem and the small window of time for which a solution would be relevant. Accordingly, participants in the secondary market for mortgage loans, mortgage servicing rights, and mortgage-backed securities suffer from inaccurate pricing calculations due to static parameters being used to model variables.

Further, market participants in complex assets seek accurate and robust valuations for risk management, accounting, regulatory compliance, and offering bids on assets for sale. Problems associated with both valuations and price setting using existing methods as they relate to holders, purchasers, and sellers of complex assets exist.

Regarding complex asset valuation, valuation providers are typically not price providers. Valuation and pricing from multiple models are typically inconsistently reported and involve highly skilled practitioners to normalize and compare. Bulk valuations are usually difficult and take a significant time to perform.

Regarding holders of complex assets utilizing periodic valuations, a buyer setting a bid price in response to seller requests for quotes (RFQs) typically performs additional steps to derive a price from a valuation. Sellers use one service to get a valuation and another process (usually an expensive brokered process) to find liquidity from interested investors when they need to sell their assets. Valuations are not guaranteed representations of fair market value for assets and represent the view of one market participant.

Complex, non-standard assets typically involve highly skilled analysts to develop sophisticated models for assessing their value. In cases where software has been developed specifically for an asset class, a valuation typically involves extensive configuration by a highly skilled practitioner that involves time to set up and then time to run, resulting in a process that cannot be completed while an end consumer of the analysis waits.

Holders of assets are mandated by regulations by which their assets are independently analyzed periodically. Participants in asset markets usually value knowing what their assets are worth as frequently as possible. Performing a “valuation” on an asset population is typically an extremely time intensive and manual exercise involving multiple manual steps from highly skilled staff and often involving proprietary software that is expensive to license and run. The time and expense of performing valuations impact a holder's decision of which populations are valued and how often.

Industry standard response time for firms performing complex valuations for clients averages weeks in duration. Due to the prohibitive costs of doing standard valuations and the loss of value in receiving a valuation weeks after identifying that a valuation should be performed, asset market participants highly value alternative methods for knowing whether their asset values are moving and by how much (e.g., including calling other market participants to learn anecdotal “market color” on the strength or weakness of bids others might have seen or heard about). Accordingly, conventional methods are too slow, too arduous, too unreliable, and too expensive for asset holders.

Regarding complex asset pricing, traditional co-issue methods are unsuitable and may not be used for bulk. Bulk bid responses to RFQs are difficult and slow. Also, a time and expense of vetting counterparties and negotiating deal terms impacts liquidity and seller decisions. Due to the complexity of generating bids, bids are typically offered “all or none” and sellers lose liquidity.

Solutions in the industry exist to price new assets using an antiquated method of linear assignment of price adjusters based on individual collateral characteristics, which result in relatively accurate average pricing on a total population of assets using the law of averages such that assets that are overpriced are offset by loans that are underpriced. This is accepted by the industry despite vulnerabilities from intentional bad actors who tailor populations such that they sell the loans that are overpriced by a purchaser. The risk of this vulnerability is somewhat mitigated by purchasers by reducing the overall price they publish. Lower mortgage asset prices are directly reflected by higher mortgage rates, and these costs are ultimately passed on to potential homebuyers, putting the cost of home ownership out of reach for some. Traditional methods for pricing new complex assets are deficient for this purpose, and buyers do not make use of them when setting prices for more complex seasoned assets with more dimensions impacting safety of returns.

Accordingly, the problem to be addressed is the provable inaccuracy of current status quo shared pricing that is ubiquitous in the industry. Separate linear functions of loan collateral characteristics and distance of note rate to a benchmark is inherently inaccurate and vulnerable to abuse and makes home ownership less affordable for all homeowners. Fundamentally, as each loan characteristic changes from one loan to the next, a true valuation model on that loan will result in differences in price that deviate significantly from a price derived using linear functions on each characteristic separately. The problem is how to replicate the accuracy of a full valuation model in a format that can be shared with others such that others can apply that model to an intended asset population, and obtain loan level valuation-based pricing nearly instantly in a self-serve interface (e.g., without any significant training, and/or without difficult-to-use and expensive proprietary software) so that purchasers can provide their true price without fear of abuse (e.g., which in turn leads to higher prices and lower mortgage rates and more people being able to afford homes).

Investor responders to RFQs seeking to make responsible competitive bids for complex assets traditionally set up a portfolio file for analysis using their established valuation model, configure that model to handle specifics of a deal, and then run the model. To target a precise percentage return on investment, a bid price is generated by subtracting a calculated percentage from the valuation level.

Typically, a non-trivial amount of time is taken to run a valuation on a new portfolio including normalizing the population data file, operating the expensive valuation software, outputting the results, and formatting results for reports and sharing. It takes further non-trivial time to determine pricing based on valuation model results. For sellers sending out RFQs in the traditional method, it routinely takes days to receive bids back from one or more investors. Sellers often work through expensive brokers to access bids from a wider pool of potential buyers. The time and expense of performing valuations and conducting RFQ events accordingly impacts how often users perform valuations and monitor pricing for their assets.

The exemplary disclosed system and method of the present disclosure is directed to overcoming one or more of the shortcomings set forth above and/or other deficiencies in existing technology.

### SUMMARY OF THE DISCLOSURE

In one exemplary aspect, the present disclosure is directed to a system. The system includes a mortgage servicing and loan valuation module, comprising computer-executable code stored in non-volatile memory, a processor, and a network component configured to communicate with the mortgage servicing and loan valuation module and the processor. The mortgage servicing and loan valuation module, the processor, and the network component are configured to receive a pricing file via the network component, provide a plurality of machine learning regression models, determine one or more of the plurality of machine learning regression models to apply to the pricing file, apply the determined one or more of the plurality of machine learning regression models to the pricing file, and transfer a priced portfolio to the network component.

In another aspect, the present disclosure is directed to a method. The method includes receiving a pricing file via a network component, providing a plurality of k-nearest neighbors models, determining one or more of the plurality of k-nearest neighbors models to apply to the pricing file using a mortgage servicing and loan valuation module and a processor, applying the determined one or more of the plurality of k-nearest neighbors models to the pricing file, and transferring a priced portfolio to the network component.

In another aspect, the present disclosure is directed to a system. The system includes a mortgage servicing and loan valuation module, comprising computer-executable code stored in non-volatile memory, a processor, and a user interface configured to communicate with the mortgage servicing and loan valuation module and the processor. The mortgage servicing and loan valuation module, the processor, and the user interface are configured to receive a full loan valuation data of a buyer, select a plurality of loan samples based on the full loan valuation data, determine a function data file based on the full loan valuation data and the plurality of loan samples using machine learning operations, transform a seller asset data of a seller, which includes a plurality of assets, to a normalized data structure, determine a subset of the plurality of assets by applying the function data file to the normalized data structure, and receive a commit data from the seller committing to a purchase of the subset of the plurality of assets by the buyer.

In another aspect, the present disclosure is directed to a method. The method includes receiving a full loan valuation data of a buyer, selecting a plurality of loan samples based on the full loan valuation data, determining a function data file based on the full loan valuation data and the plurality of loan samples using machine learning operations, transforming a seller asset data of a seller, which includes a plurality of assets, to a normalized data structure, determining a subset of the plurality of assets by applying the function data file to the normalized data structure, and receiving a commit data from the seller, via a user interface, committing to a purchase of the subset of the plurality of assets by the buyer.

### BRIEF DESCRIPTION OF THE DRAWINGS

Accompanying this written specification is a collection of drawings of exemplary embodiments of the present disclosure. One of ordinary skill in the art would appreciate that these are merely exemplary embodiments, and additional and alternative embodiments may exist and still within the spirit of the disclosure as described herein.

FIG. 1 is a chart illustration of at least some exemplary embodiments of the present disclosure;

FIG. 2 is a chart illustration of at least some exemplary embodiments of the present disclosure;

FIG. 3 is a chart illustration of at least some exemplary embodiments of the present disclosure;

FIG. 4 is a chart illustration of at least some exemplary embodiments of the present disclosure;

FIG. 5 is a chart illustration of at least some exemplary embodiments of the present disclosure;

FIG. 6 is a chart illustration of at least some exemplary embodiments of the present disclosure;

FIG. 7 is a chart illustration of at least some exemplary embodiments of the present disclosure;

FIG. 8 is a chart illustration of at least some exemplary embodiments of the present disclosure;

FIG. 9 is a chart illustration of at least some exemplary embodiments of the present disclosure;

FIG. 10 is a chart illustration of at least some exemplary embodiments of the present disclosure;

FIG. 11 is a chart illustration of at least some exemplary embodiments of the present disclosure;

FIG. 12 is a chart illustration of at least some exemplary embodiments of the present disclosure;

FIG. 13 is a chart illustration of at least some exemplary embodiments of the present disclosure;

FIG. 14 is a schematic illustration of at least some exemplary embodiments of the present disclosure;

FIG. 15 is a chart illustration of at least some exemplary embodiments of the present disclosure;

FIG. 16 is a schematic illustration of at least some exemplary embodiments of the present disclosure;

FIG. 17 is a chart illustration of at least some exemplary embodiments of the present disclosure;

FIG. 18 illustrates an exemplary process of at least some exemplary embodiments of the present disclosure;

FIG. 19 is a schematic illustration of at least some exemplary embodiments of the present disclosure;

FIG. 20 is a schematic illustration of at least some exemplary embodiments of the present disclosure;

FIG. 21 is a schematic illustration of at least some exemplary embodiments of the present disclosure;

FIG. 22 is a schematic illustration of at least some exemplary embodiments of the present disclosure;

FIG. 23 is a schematic illustration of at least some exemplary embodiments of the present disclosure;

FIG. 24 is a schematic illustration of at least some exemplary embodiments of the present disclosure;

FIG. 25 illustrates an exemplary process of at least some exemplary embodiments of the present disclosure;

FIG. 26 illustrates an exemplary process of at least some exemplary embodiments of the present disclosure;

FIG. 27 is a schematic illustration of an exemplary computing device, in accordance with at least some exemplary embodiments of the present disclosure;

FIG. 28 is a schematic illustration of an exemplary network, in accordance with at least some exemplary embodiments of the present disclosure; and

FIG. 29 is a schematic illustration of an exemplary network, in accordance with at least some exemplary embodiments of the present disclosure.

### DETAILED DESCRIPTION AND INDUSTRIAL APPLICABILITY

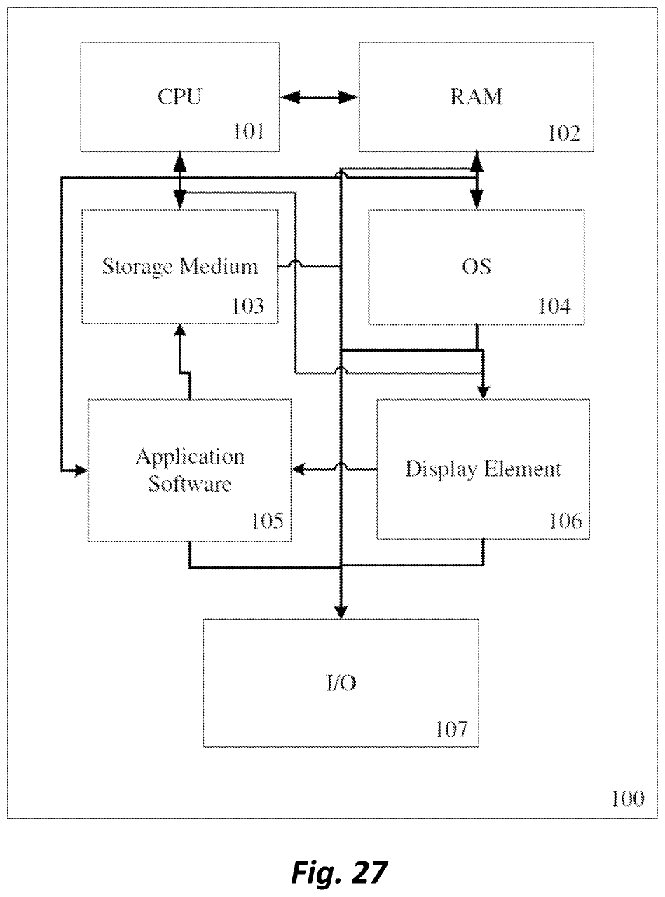

The exemplary disclosed system and method may be an automated real time mortgage servicing valuation system and method. The exemplary disclosed system may include a mortgage servicing and loan pricing engine as described for example herein. The mortgage servicing and loan pricing engine may include computing device components, modules, processors, network components, and other suitable components that may be similar to the exemplary disclosed components described below regarding FIGS. 27-29. For example, the exemplary disclosed system may include a mortgage servicing and loan valuation module, including computer-executable code stored in non-volatile memory, and a processor.

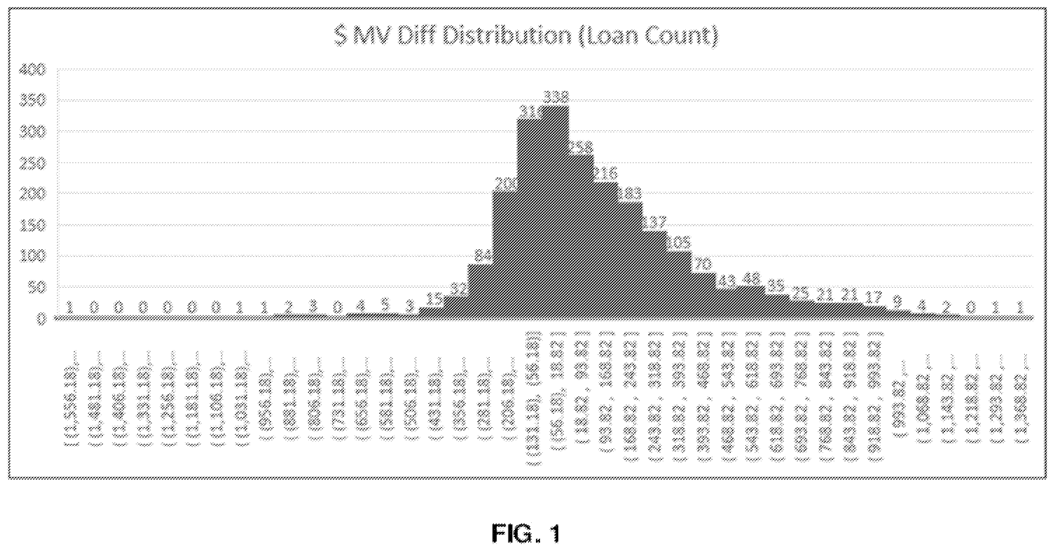

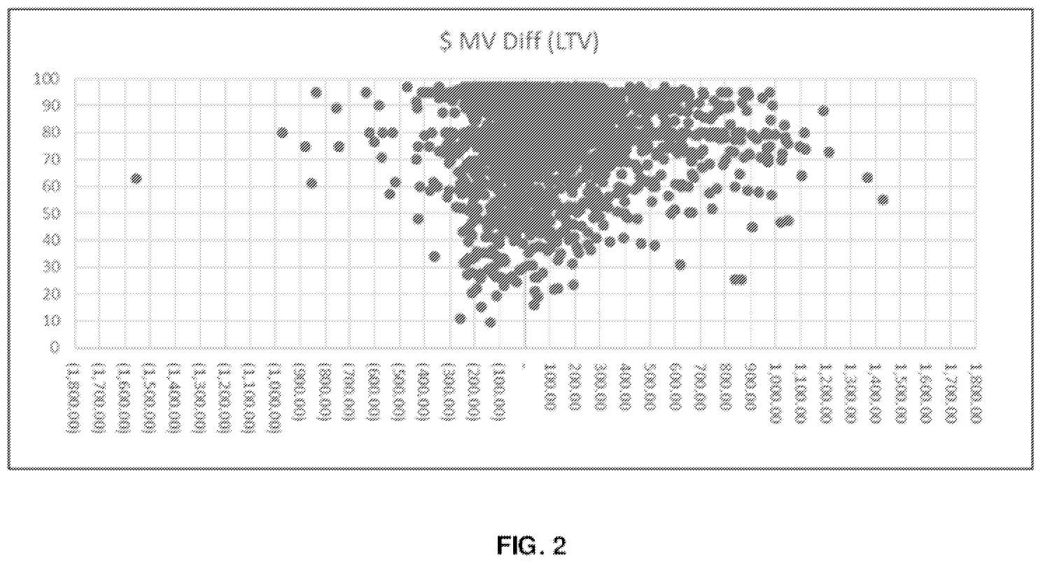

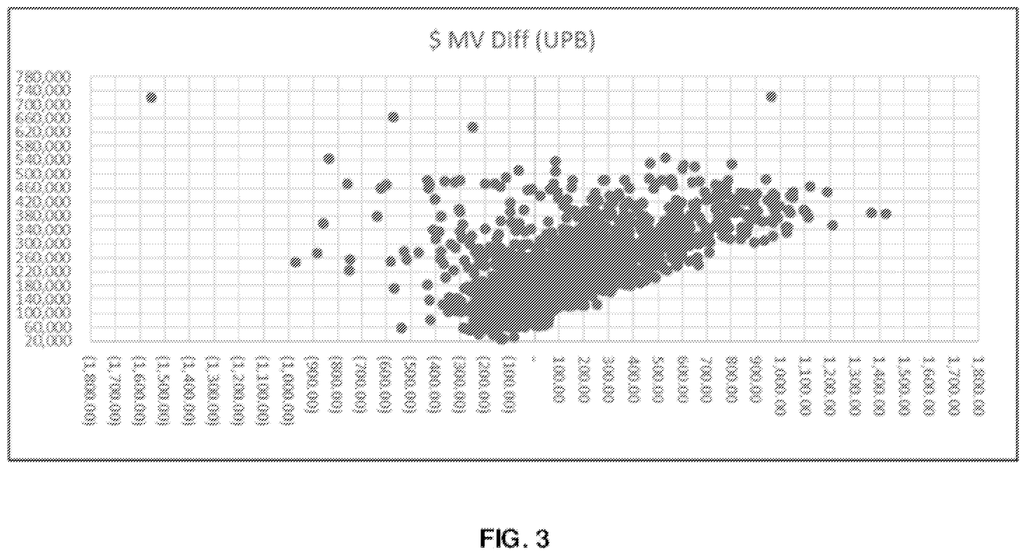

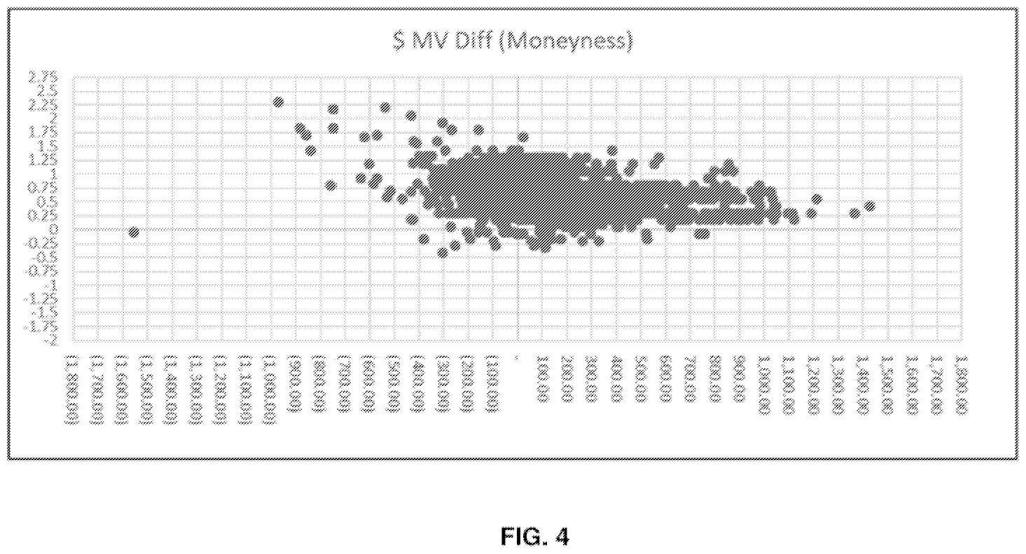

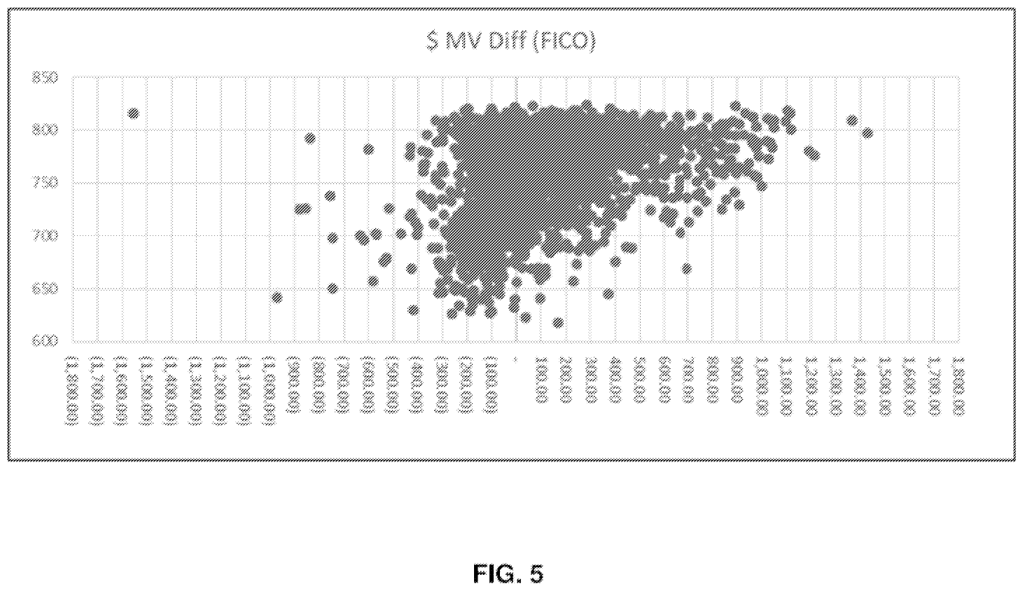

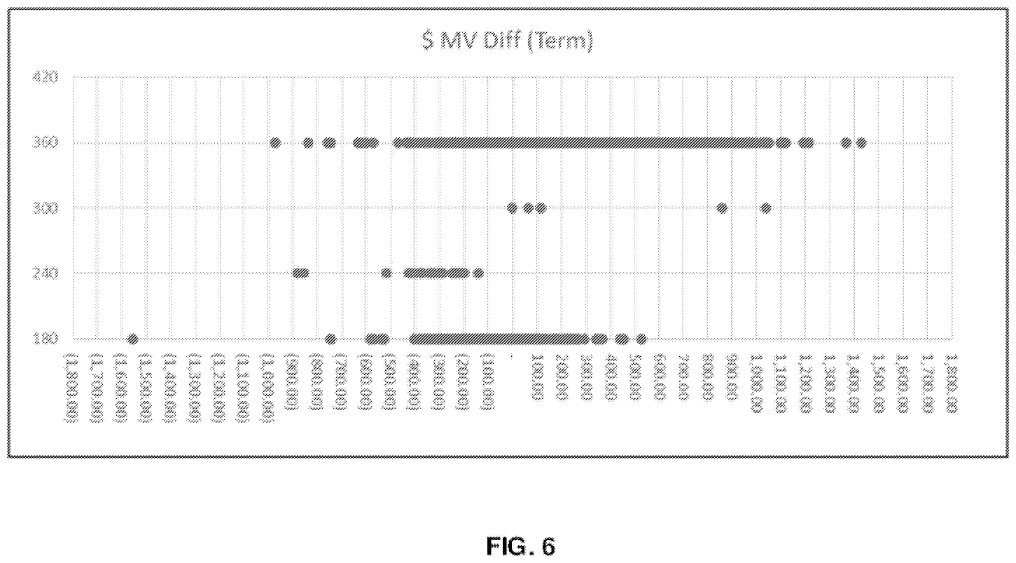

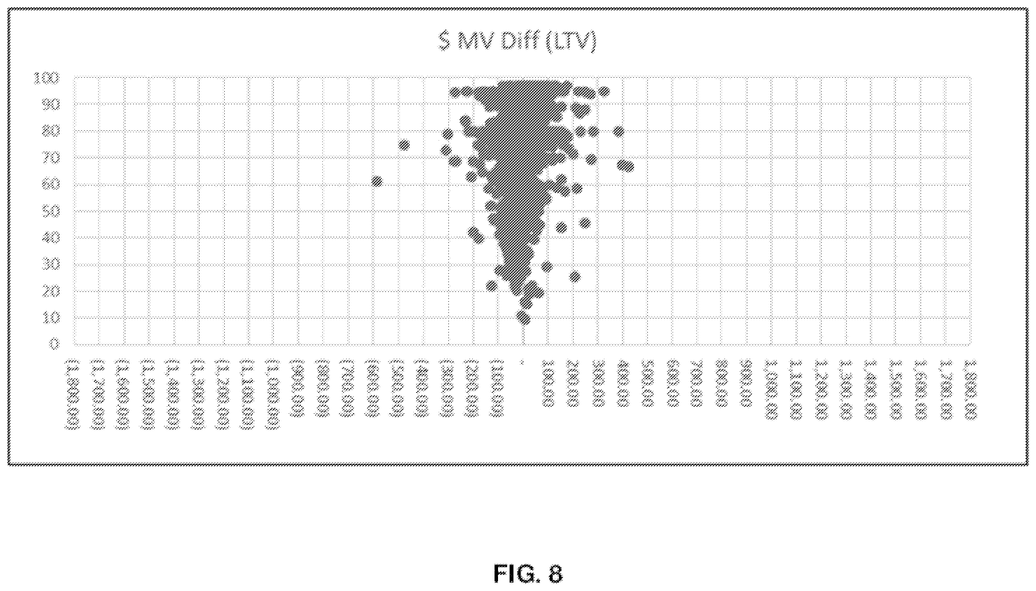

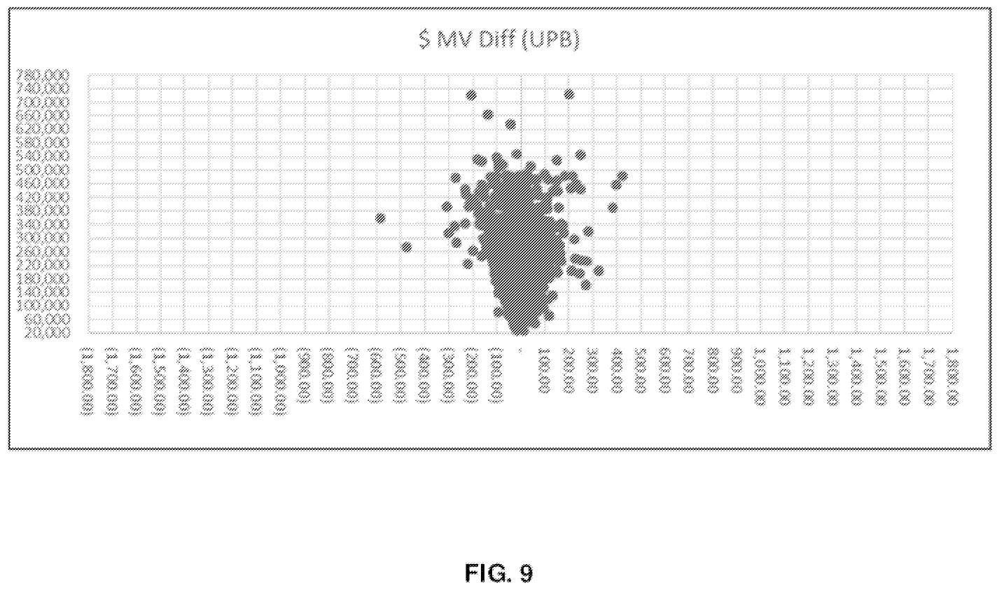

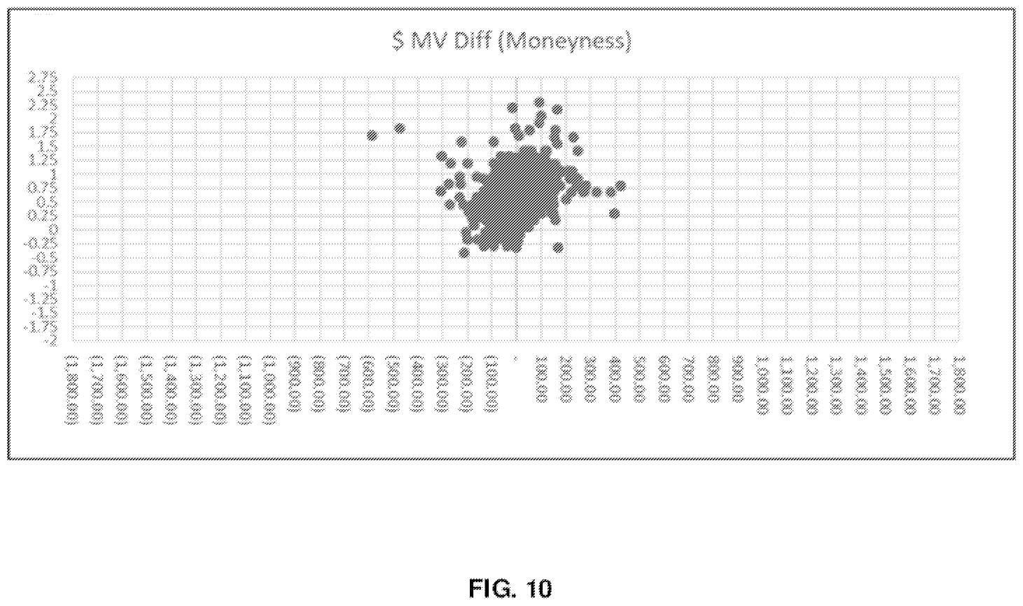

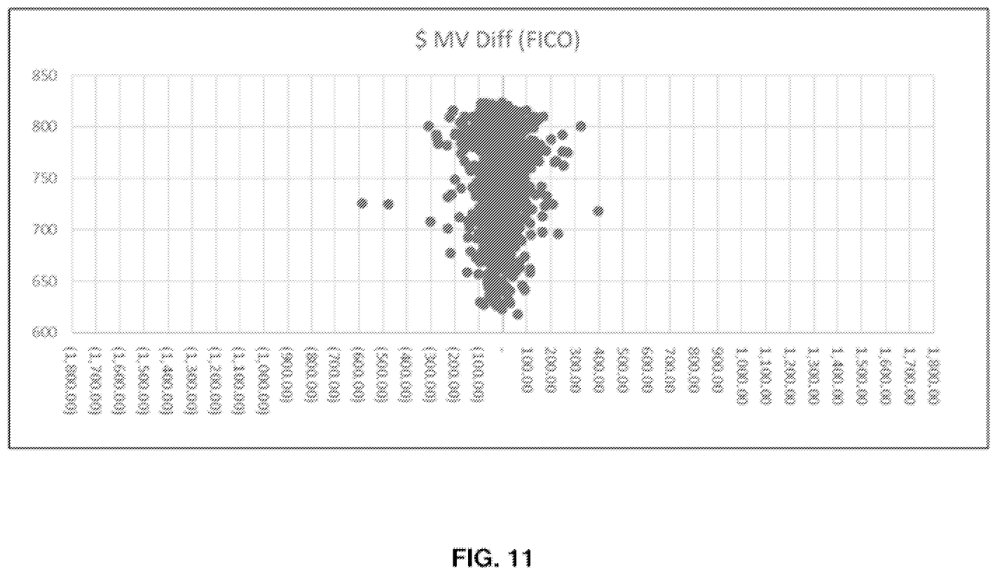

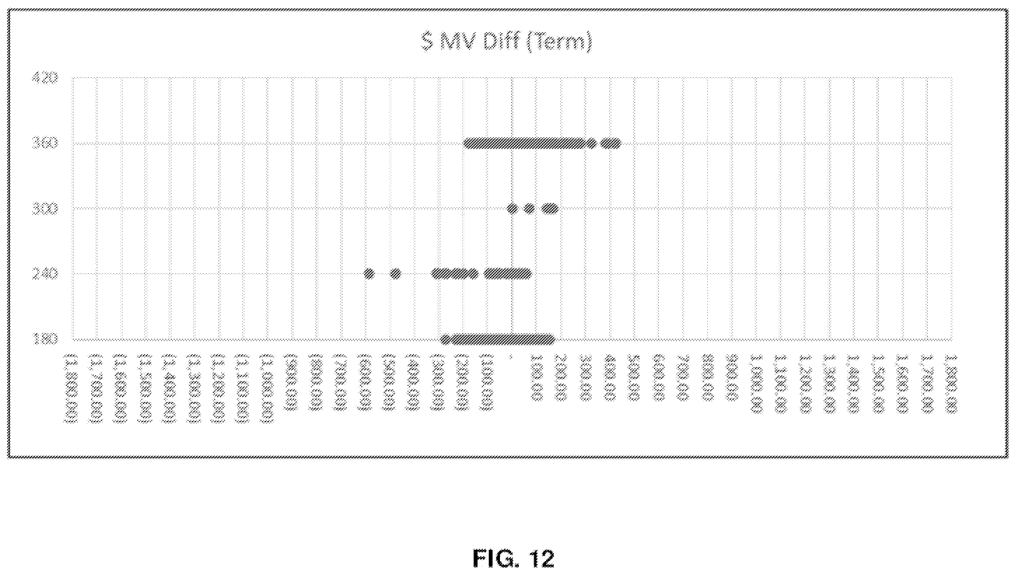

The exemplary disclosed system and method may reduce a mean error of pricing models introduced by market fluctuations within one or more time sensitive constraints present or existing during secondary mortgage market transactions (e.g., in the conduct of these transactions). For example, the mean error of pricing models introduced by market fluctuations may be reduced by exemplary disclosed statistical modeling and algorithms (e.g., software) as described herein and as illustrated in FIGS. 1-13.

The exemplary disclosed system and method may provide an efficient (e.g., streamlined) method that provides a low threshold for error, for example as desired by market participants such as participants in secondary markets for mortgages. For example, the exemplary disclosed system and method may provide participants with a digital method (e.g., fully digital method) for performing transactions. The exemplary disclosed system and method may also reduce a dimensionality of possible permutations (e.g., for solving a problem) down to a number that is computationally feasible to solve (e.g., to exhaustively solve for). The exemplary disclosed system and method may provide solutions in a practical (e.g., relatively short) period of time. The exemplary disclosed system and method may also return prices to buyers and sellers instantaneously (e.g., instantaneously or nearly instantaneously) regardless of market movements.

In at least some exemplary embodiments, the exemplary disclosed system and method may provide a low threshold for error by eliminating local maxima (e.g., all local maxima) beyond a preliminary threshold.

In at least some exemplary embodiments, the exemplary disclosed system and method may provide a low threshold for error by interpolating on a continuous plane using a regression based on k-nearest neighbors (e.g., KNN). For example, a target may be predicted based on the regression. The regression based on k-nearest neighbors may include prediction of a target by local interpretation of targets associated with nearest neighbors in a data set.

In at least some exemplary embodiments, the exemplary disclosed system and method may be platform agnostic. For example, the exemplary disclosed system may plug into any suitable third party system (e.g., third party software solutions).

In at least some exemplary embodiments, the exemplary disclosed system and method may operate in real time (e.g., real time or near real time) relative to market data sources. For example, the exemplary disclosed system and method may refresh reference market rates (e.g., certain user defined inputs such as but not necessarily limited to interest rate swap prices, secondary mortgage reference market rates, and money market instrument prices) in real time or near real time (e.g., continuously or at or any desired intervals).

The exemplary disclosed system and method may provide improved accuracy. For example, the exemplary disclosed system and method may provide a continuous pricing function that reduces error created by assigning value using discrete pricing scenarios.

The exemplary disclosed system and method may provide improved operational efficiency. For example, the exemplary disclosed system and method may provide for grids associated with secondary markets for mortgages that may be updated as desired.

In at least some exemplary embodiments, the exemplary disclosed system and method may provide a generalized method for use in any desired time sensitive applications. The exemplary disclosed system may include any suitable user interface that may be developed to any desired parameters (e.g., specified parameters). The exemplary disclosed system may also utilize machine learning techniques, as described for example below, to initialize and tune hyperparameters.

FIGS. 1-6 illustrate an exemplary comparison of Market Value ($) Variance (e.g., expressed in USD or $). For example as illustrated in FIGS. 1-6, a comparison of co-issue grids vs. loan level cash flow valuation is shown.

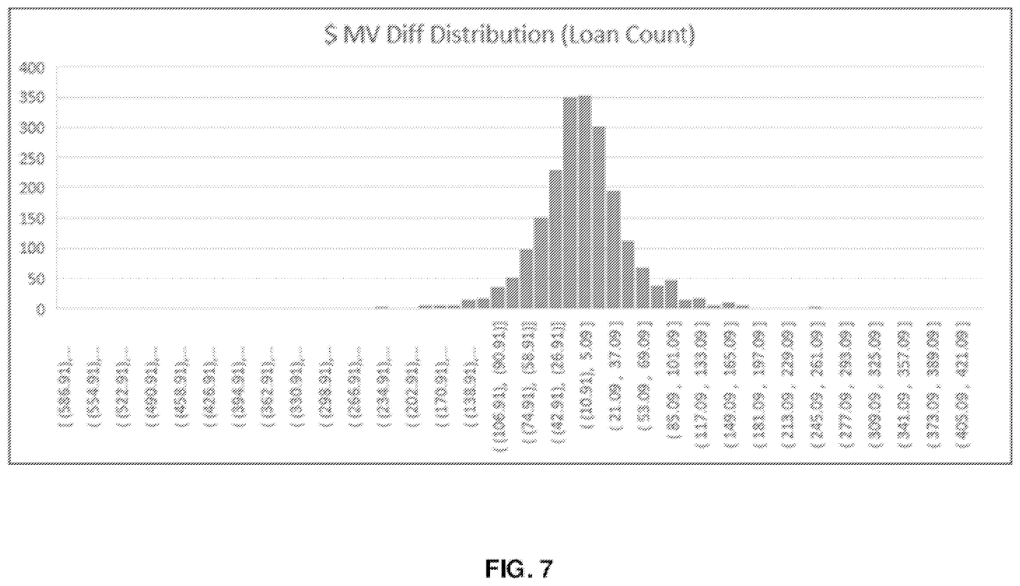

FIGS. 7-12 illustrate an exemplary comparison of Market Value ($) Variance (e.g., expressed in USD or $). For example as illustrated in FIGS. 7-12, a comparison of an embodiment of the exemplary disclosed system (e.g., Blue Water API) vs. loan level cash flow valuation is shown.

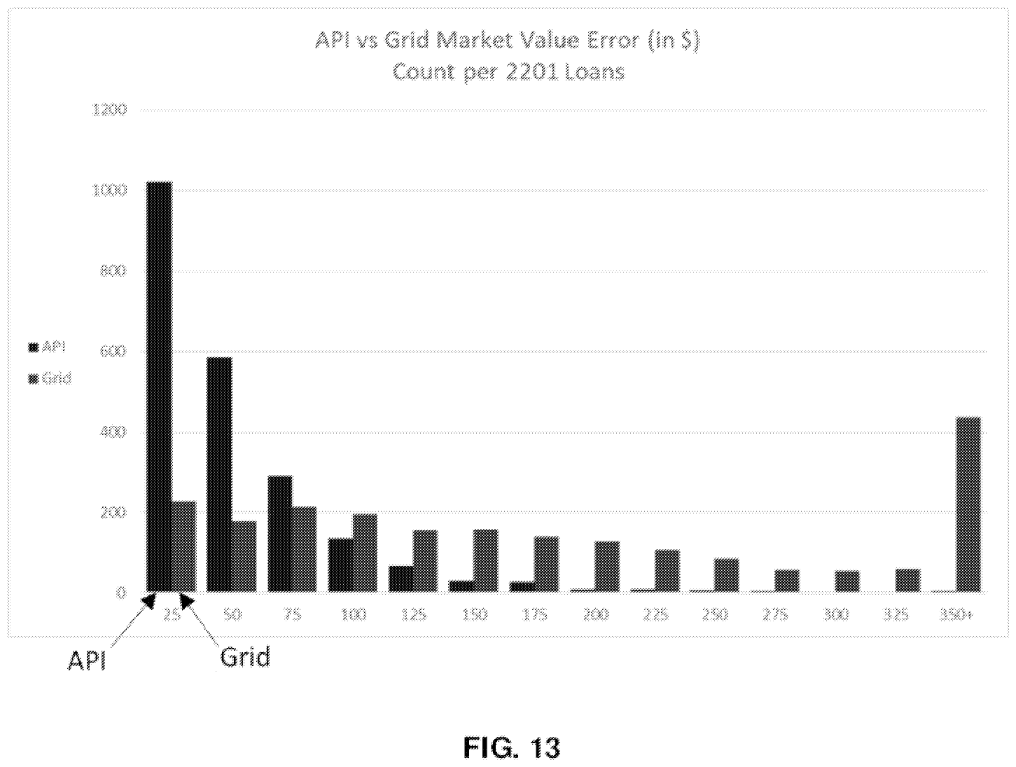

FIG. 13 illustrates an exemplary comparison of Market Value ($) Variance (e.g., expressed in USD or $). For example as illustrated in FIG. 13, a comparison of an embodiment of the exemplary disclosed system (e.g., an Application Programming Interface such as any suitable cloud-based or Internet-based API such as for example Blue Water API) vs. an exemplary disclosed grid is shown. FIG. 13 illustrates an exemplary comparison using the same set of loans (e.g., 2201 loans) and market rates.

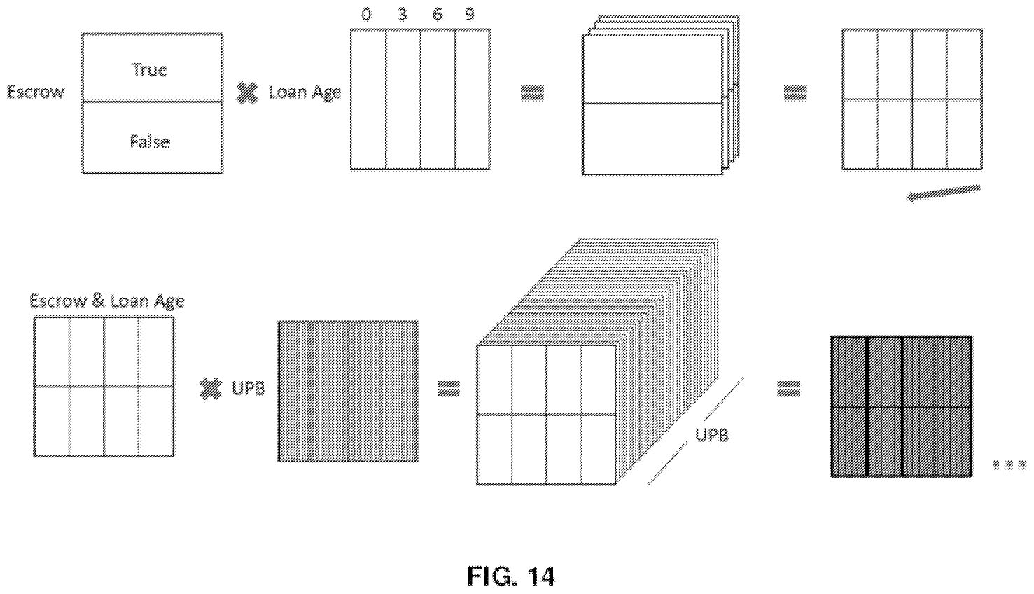

FIGS. 14-17 illustrate an exemplary operation of the exemplary disclosed system and method. As illustrated in FIG. 14, the exemplary disclosed system may create a pricing file (e.g., a Bulk Loan Level Pricing File such as a bulk mortgage loan level pricing file) and provide the pricing file to a user such as a client. The user may price the pricing file and provide the pricing file as input data to the system. The exemplary disclosed system may determine a Par Note Rate construction (e.g., based on the operation of the system and input from the user). The exemplary disclosed system may standardize the pricing file input by the user (e.g., the returned pricing file) and may upload the standardized pricing file to a backend database of the exemplary disclosed system. The exemplary disclosed system may price (e.g., based on the operation of the system and input from the user) a sample portfolio (e.g. about 2000 recent loans) using any suitable data and/or criteria such as a model input as data by the user (e.g., a client's model) and/or software or algorithms of the exemplary disclosed system. The exemplary disclosed system may reconcile pricing and agree to aggregate price tolerances (e.g., based on an operation of the system and input from the user). The exemplary disclosed system may determine a frequency of refresh of the pricing file (e.g., based on an operation of the system and input from the user). A multiple k-nearest neighbors (e.g., KNN) model may be applied to the pricing file by the exemplary disclosed system and method for example as described below.

As illustrated in FIG. 14, the exemplary disclosed pricing file may be constructed from any desired permutations (e.g., all permutations) across multiple inputs: for example, note rate, escrow, loan age, UPB (unpaid principal balance), LTV (loan-to-value ratio), FICO (e.g., including FICO® score data), DTI (debt-to-income ratio), and any other suitable inputs.

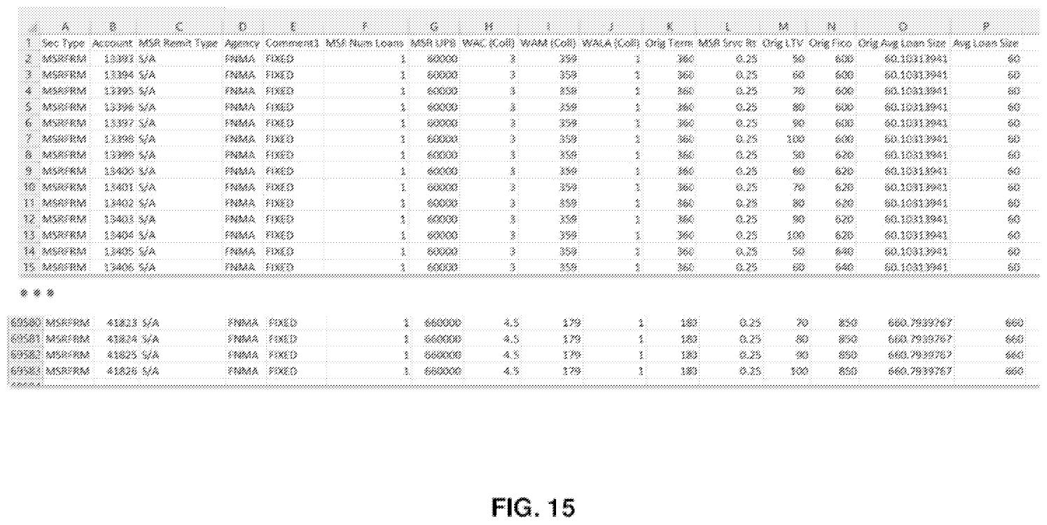

As illustrated in FIG. 15, when a user (e.g., a buyer or a client) runs the exemplary disclosed pricing file through a user's process (e.g., the user's loan-level valuation method) and provides data of the results to the exemplary disclosed system, the exemplary disclosed system may perform the exemplary disclosed method with a granular representation (e.g., much more granular representation, relatively) of some or all possible loan permutations. The exemplary disclosed system may then interpolate between the granular population and achieve near continuous pricing in some or all possible market states and loan characteristics.

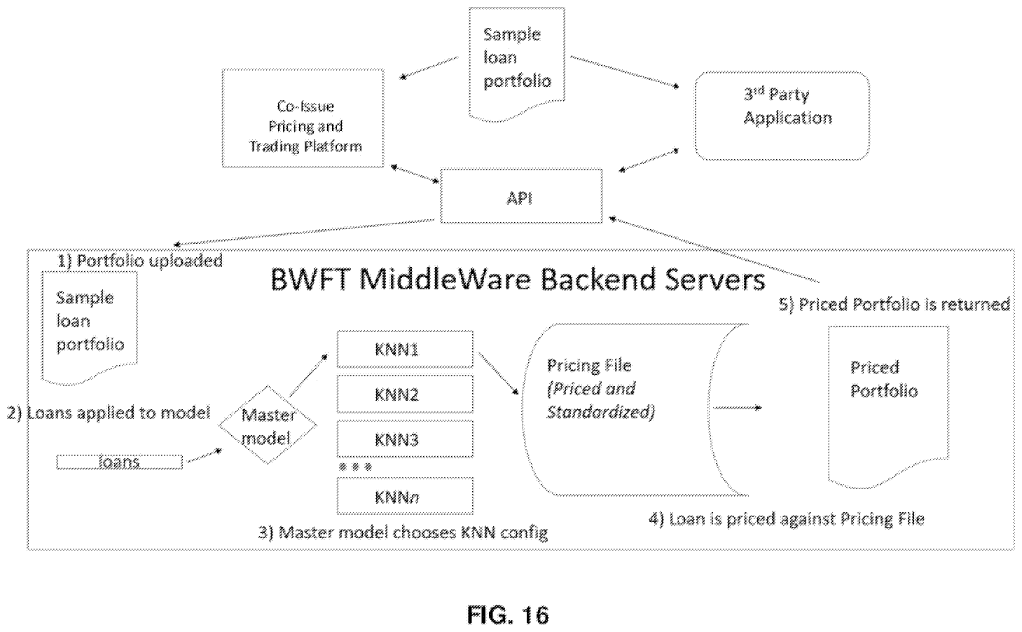

FIG. 16 illustrates a diagram of an exemplary embodiment of a master model. The exemplary disclosed master model may utilize any suitable regression method or model such as a non-parametric method or model. The exemplary disclosed master model may utilize a machine learning algorithm or model for solving regression problems. For example, the exemplary disclosed master model may utilize a plurality of machine learning regression models. In at least some exemplary embodiments, the exemplary disclosed system and method may include a multiple k-nearest neighbors (e.g., KNN) model, e.g., designed based on domain knowledge: F(KNN1, KNN2 . . . KNNn). The exemplary disclosed system and method (e.g., the master model) may determine (e.g., select) which KNN to use (e.g., may also be designed based on domain knowledge). For example, a priced pricing file may be uploaded via API, a multiple KNN model may be applied (e.g., the master model may determine or select a best performing KNN model), and the API may return prices. If more than one KNN model has been selected by the master function, the result may be based on the weighted average of all the selected model result. The exemplary disclosed system and method may utilize artificial intelligence operations (e.g., lazy learning and/or instance-based learning) for example as described herein in determining one or more KNN models to apply to the pricing file.

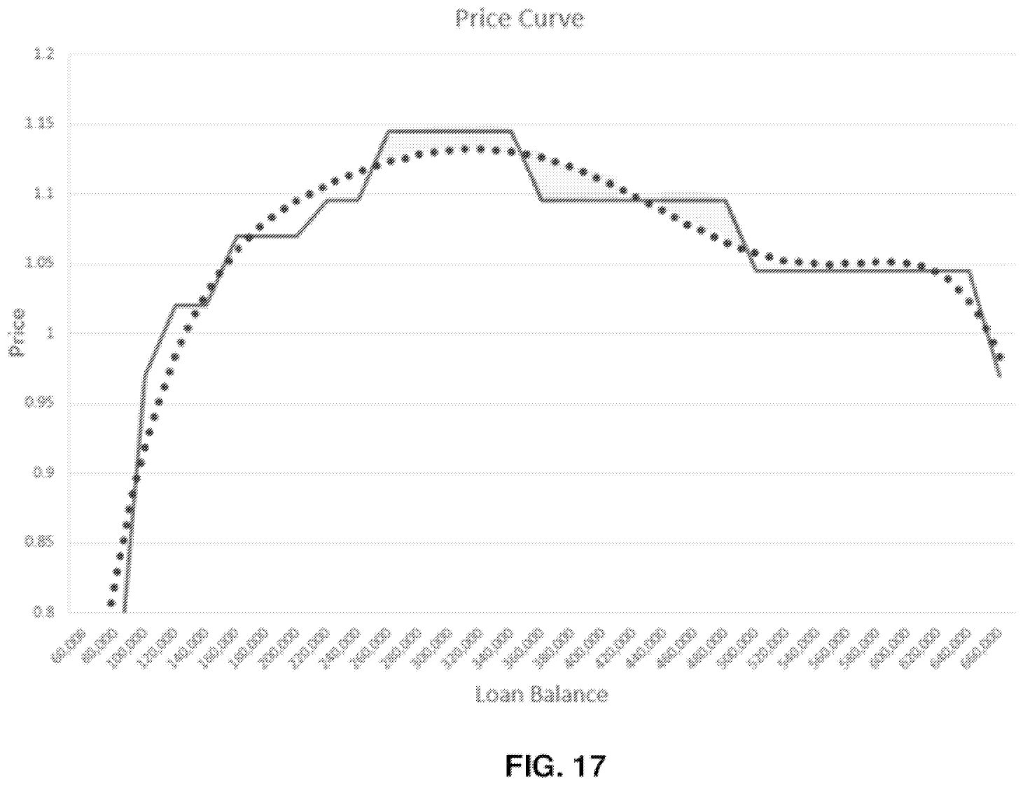

As illustrated in FIG. 17, the exemplary disclosed system and method (e.g., including a Middleware solution) may effectively price loans on a continuous plane, while static grids may be in (e.g., stuck in) discrete buckets. The shaded area shown in FIG. 17 depicts inaccuracies of grids that may exist as compared to the exemplary disclosed method (e.g., using Middleware).

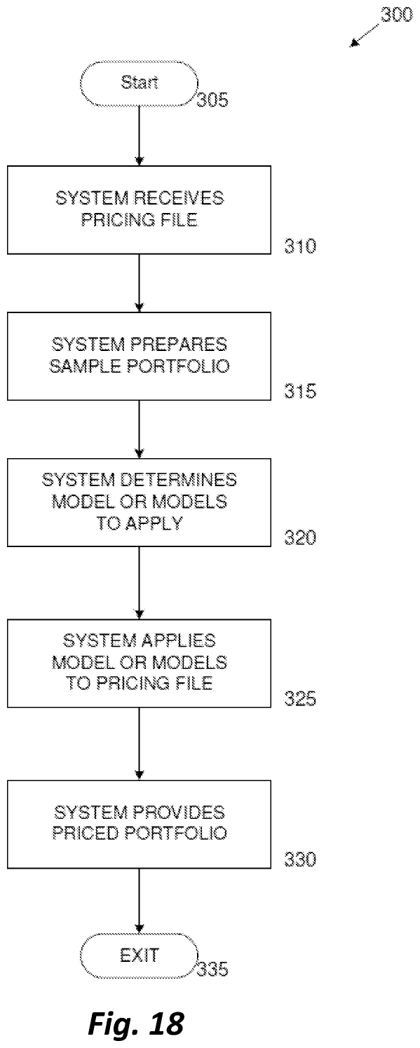

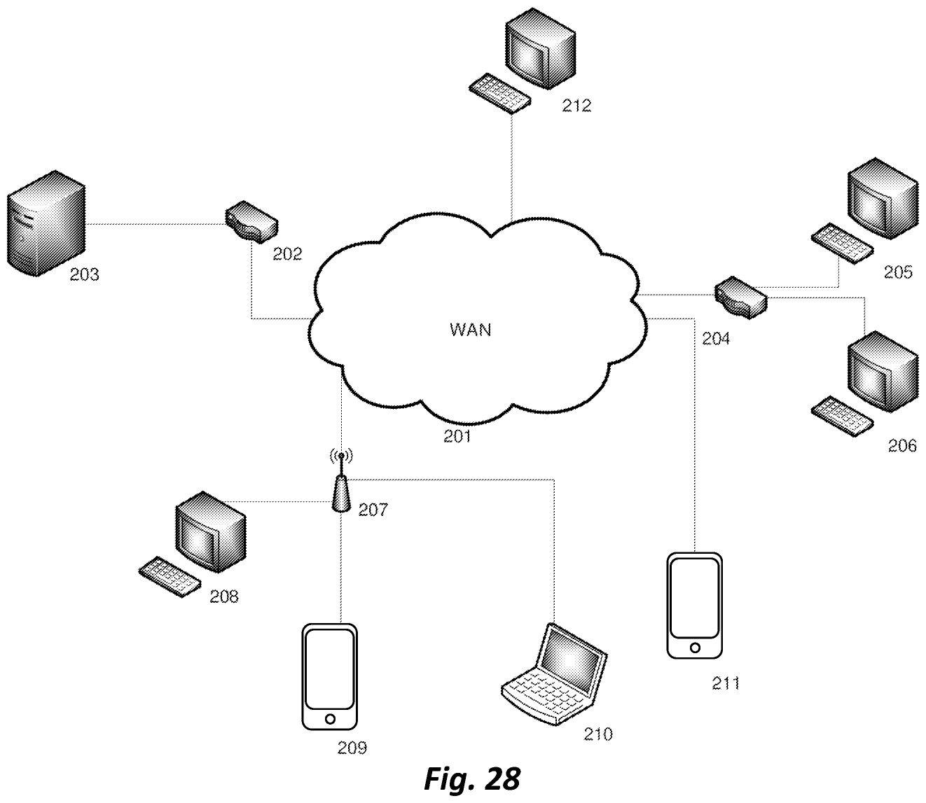

FIG. 18 illustrates an exemplary operation of the exemplary disclosed system. Process 300 begins at step 305. At step 310, the exemplary disclosed system may receive a pricing file (for example from a user). The pricing file may be received by any suitable technique such as cloud-based methods (e.g., uploaded via API) or any other suitable technique for example as described herein. For example, the pricing file may be received via a network component of the exemplary disclosed system that may for example be similar to the network components described herein regarding FIG. 28. At step 315, the exemplary disclosed system may upload and/or prepare a sample portfolio (e.g., a sample loan portfolio including loans).

At step 320, the exemplary disclosed system may determine a model or models to apply to the pricing file. For example as described above, the exemplary disclosed system may operate to select one or more regression (e.g., KNN) models to apply to the pricing file.

The exemplary disclosed system may apply the selected regression (e.g., KNN) model or models to the pricing file at step 325. For example as described above, the exemplary disclosed system may maintain a low threshold for error by eliminating local maxima (e.g., all local maxima) beyond a preliminary threshold. Also for example as described above, the exemplary disclosed system may provide a low threshold for error by interpolating on a continuous plane using a regression based on k-nearest neighbors. In at least some exemplary embodiments, loans (e.g., loans of the sample portfolio) may be priced against the pricing file at step 325.

At step 330, the exemplary disclosed system may provide the priced portfolio to the user. The priced portfolio may be provided for example by the exemplary disclosed techniques described herein (e.g., cloud-based methods such as via an API) via the exemplary disclosed network component. Process 300 ends at step 335.

In at least some exemplary embodiments, the exemplary disclosed system and method may be a system and method for mortgage servicing valuation. The system and method may include a mortgage servicing and loan pricing engine. The system and method may reduce a mean error of pricing models introduced by market fluctuations within one or more time sensitive constraints present or existing during secondary mortgage market transactions.

In at least some exemplary embodiments, the exemplary disclosed system may include a mortgage servicing and loan valuation module, comprising computer-executable code stored in non-volatile memory, a processor, and a network component configured to communicate with the mortgage servicing and loan valuation module and the processor. The mortgage servicing and loan valuation module, the processor, and the network component may be configured to receive a pricing file via the network component, provide a plurality of machine learning regression models, determine one or more of the plurality of machine learning regression models to apply to the pricing file, apply the determined one or more of the plurality of machine learning regression models to the pricing file, and transfer a priced portfolio to the network component. The mortgage servicing and loan valuation module, the processor, and the network component may be further configured to receive a plurality of update data for the pricing file in real time. The plurality of update data for the pricing file may include real time changes to reference market rates. The plurality of machine learning regression models may be a plurality of k-nearest neighbors models. Applying the determined one or more of the plurality of machine learning regression models to the pricing file may include eliminating all local maxima beyond a preliminary threshold. Applying the determined one or more of the plurality of machine learning regression models to the pricing file may include interpolating on a continuous plane using a regression based on k-nearest neighbors. The pricing file may be a bulk mortgage loan level pricing file. The pricing file may include at least one data selected from the group of note rate data, escrow data, loan age data, UPB data, LTV data, FICO data, DTI data, and combinations thereof. The network component may include an internet-based API. Applying the determined one or more of the plurality of machine learning regression models to the pricing file may include interpolating between a granular population to provide continuous pricing in all market states and loan characteristics.

In at least some exemplary embodiments, the exemplary disclosed method may include receiving a pricing file via a network component, providing a plurality of k-nearest neighbors models, determining one or more of the plurality of k-nearest neighbors models to apply to the pricing file using a mortgage servicing and loan valuation module and a processor, applying the determined one or more of the plurality of k-nearest neighbors models to the pricing file, and transferring a priced portfolio to the network component. Determining one or more of the plurality of k-nearest neighbors models to apply to the pricing file using a mortgage servicing and loan valuation module and a processor may include utilizing machine learning operations. The exemplary disclosed method may also include receiving a plurality of update data for the pricing file. The exemplary disclosed method may further include updating the pricing file in real time as each of the plurality of update data is received. The plurality of update data may include real time changes to reference market rates.

In at least some exemplary embodiments, the exemplary disclosed system may include a mortgage servicing and loan valuation module, comprising computer-executable code stored in non-volatile memory, a processor, and a network component including an API and configured to communicate with the mortgage servicing and loan valuation module and the processor. The mortgage servicing and loan valuation module, the processor, and the network component may be configured to receive a pricing file via the network component, provide a plurality of k-nearest neighbors models, determine one or more of the plurality of k-nearest neighbors models to apply to the pricing file, apply the determined one or more of the plurality of k-nearest neighbors models to the pricing file, transfer a priced portfolio to the network component, and receive a plurality of update data for the pricing file in real time. The mortgage servicing and loan valuation module, the processor, and the network component may be further configured to update the pricing file in real time as each of the plurality of update data is received. The plurality of update data for the pricing file may include real time changes to reference market rates. Applying the determined one or more of the plurality of k-nearest neighbors models to the pricing file may include eliminating all local maxima beyond a preliminary threshold. Applying the determined one or more of the plurality of k-nearest neighbors models to the pricing file may include interpolating on a continuous plane using a regression based on k-nearest neighbors.

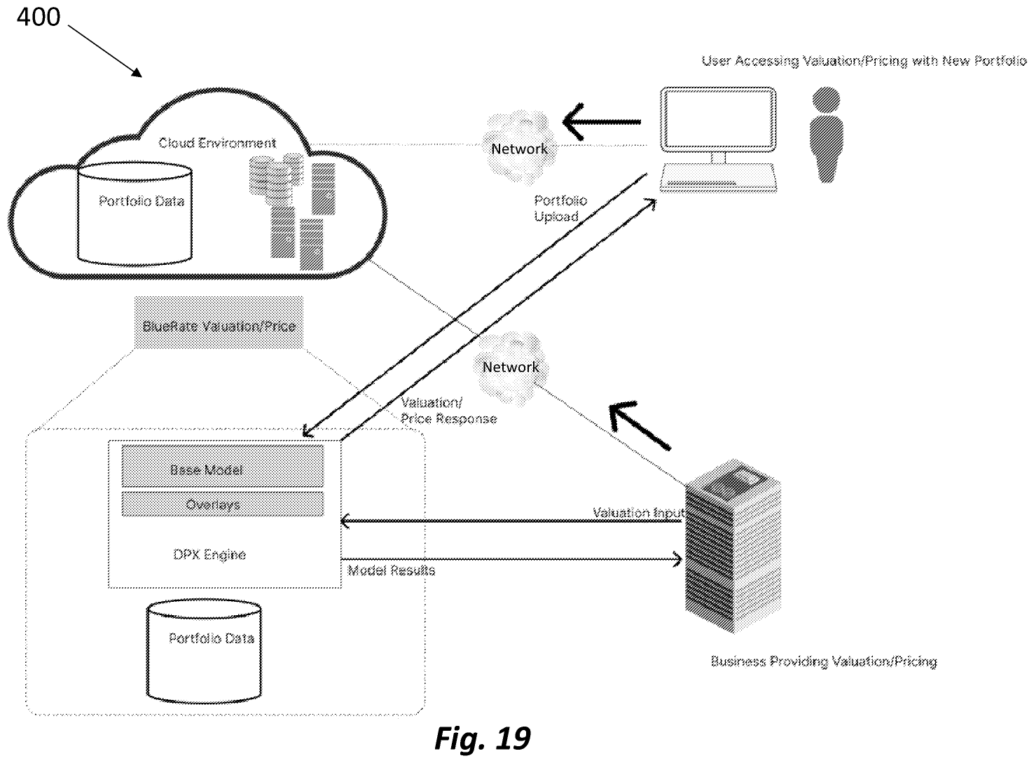

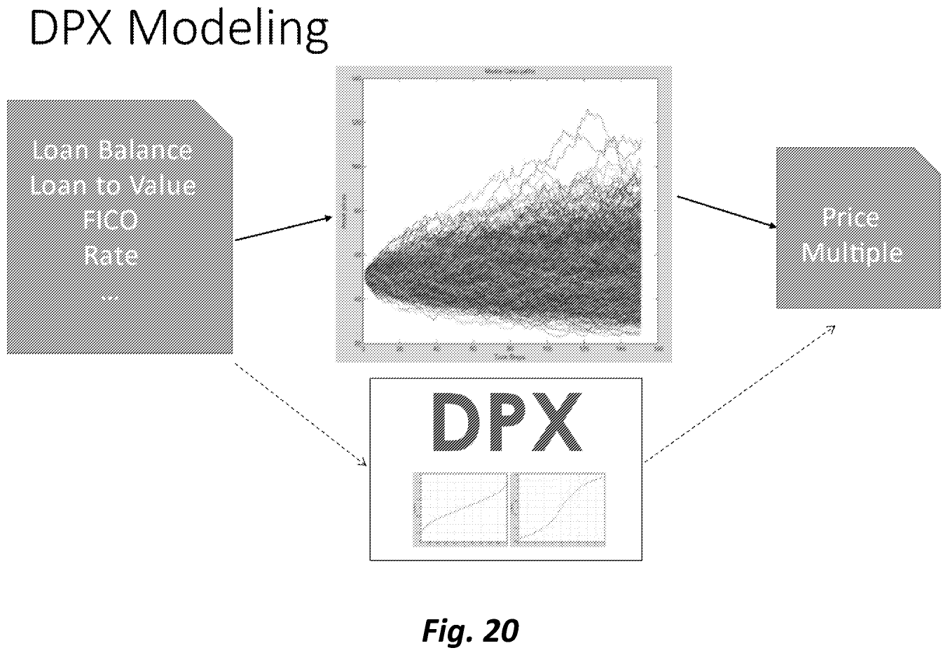

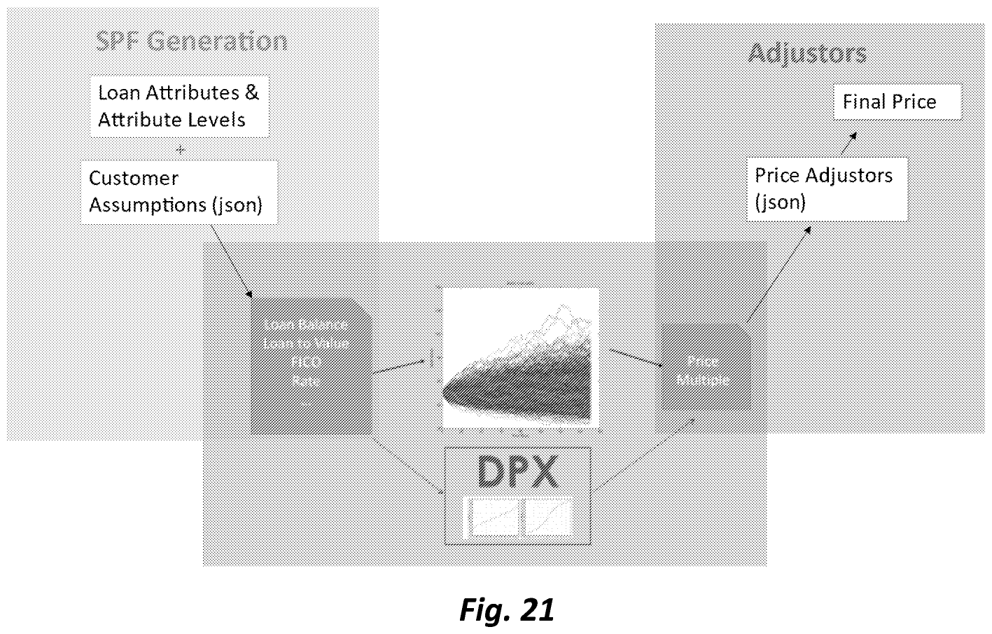

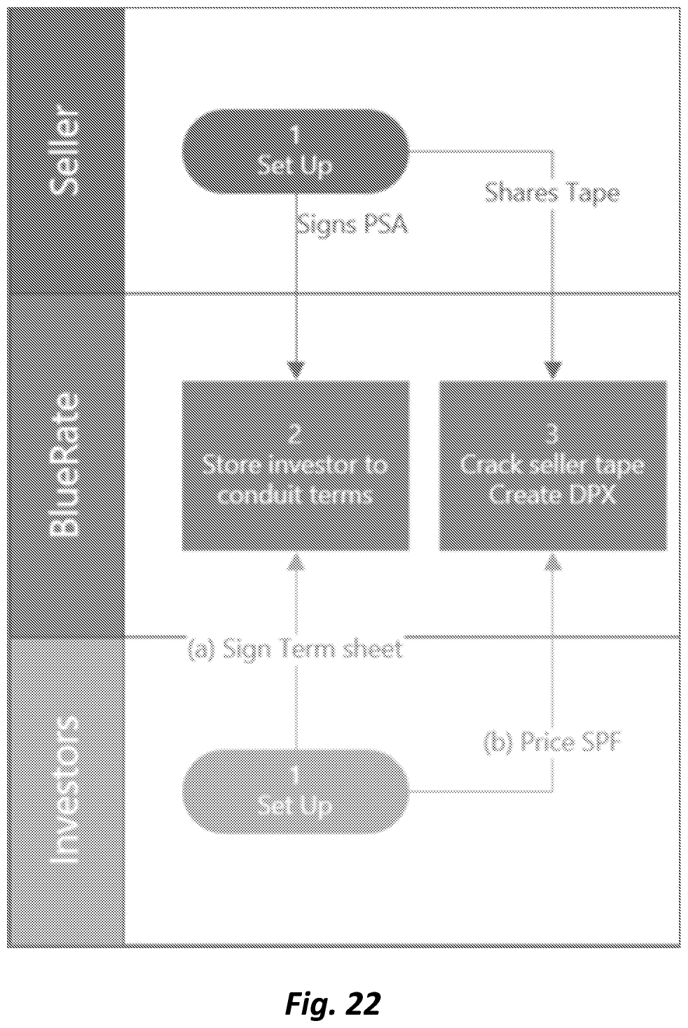

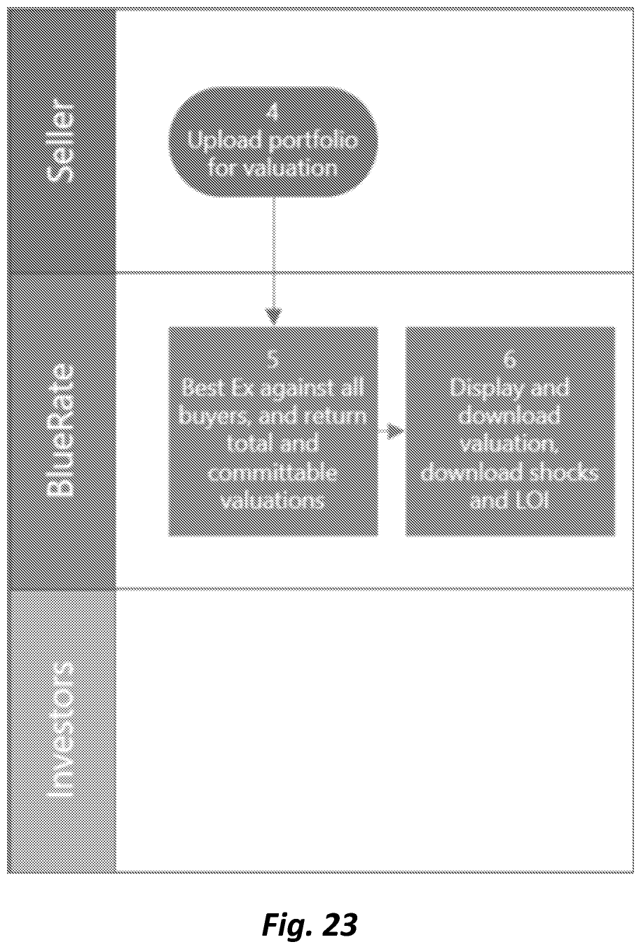

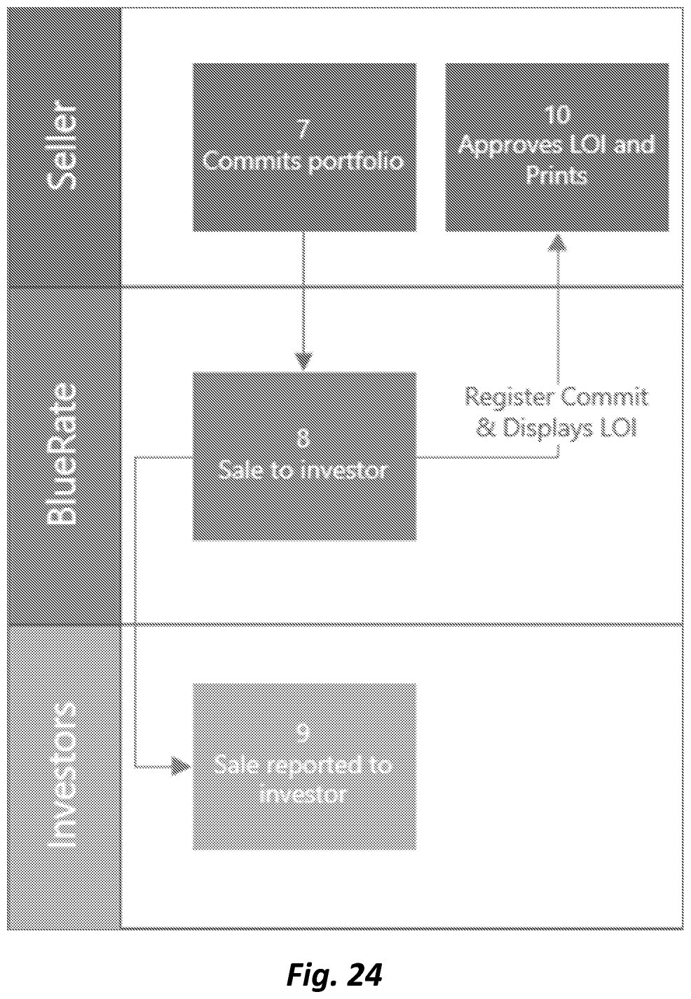

FIGS. 19-24 illustrate another exemplary embodiment of the exemplary disclosed system and method. System 400 may provide real-time delivery (e.g., real-time and/or near real-time delivery) of non-trivial valuation models, self-serve transactions, and/or reporting that may be integrated into one platform user interface. FIG. 19 illustrates exemplary disclosed components of system 400. FIGS. 20 and 21 illustrate leveraging system 400 (e.g., including DPX) to provide pricing (e.g., highly accurate base pricing) layered with adjustments (e.g., optional additional adjustments). FIG. 22 illustrates a setup of buyers and sellers such as, for example, a one-time setup of buyers and sellers. FIG. 23 illustrates exemplary disclosed pricing and analytics provided by system 400. FIG. 24 illustrates an exemplary disclosed transaction provided by system 400. In at least some exemplary embodiments and as illustrated in FIGS. 19-24, the DPX components of the exemplary system may provide the technological framework for the exemplary disclosed BlueRate system. The exemplary disclosed system and method (e.g., system 400 illustrated in FIGS. 19-24) are further described below.

The exemplary disclosed system and method (e.g., system 400 illustrated in FIGS. 19-24) may include a multi-part SaaS (Software as a Service) tool for holders, buyers, and/or sellers of non-standard assets involving valuation and pricing services using non-trivial models and processes. The exemplary disclosed system and method may reduce a time spent by highly skilled practitioners (e.g., by a factor proportional to the number of opportunities present) by providing specific user interface screens for each user role, providing a method for buyers to automate and share dynamic asset valuations and pricing in real-time (e.g., within close or extremely close tolerances of existing valuation methods on which they are based), and/or providing a technique for users to access self-serve real-time (e.g., real-time and/or near real-time) pricing and valuations for example in seconds or minutes. System 400 may also provide a method for sellers of complex assets to securely log in to a graphical user interface, and enter a legal contract to sell based on those real-time prices, thereby for example benefiting from liquidity, transparency, and relative certainty.

The exemplary disclosed method (e.g., of system 400) may include sending (e.g., in some but not all cases) a population of complex assets to a business to be valued by the business using that business's normal valuation method. The exemplary disclosed method may also include receiving from a business a population of complex assets that have been valued using that business's normal valuation method. The exemplary disclosed method may further include receiving market values used to perform the valuation. The market values may include instrument and index pricing published by 3^{rd} party data vendors. The exemplary disclosed method may also include receiving a formula (e.g., any suitable formula) used to combine future market values for use in future valuations. The exemplary disclosed method may further include receiving new populations of complex assets for which valuation models may be available from businesses. The exemplary disclosed method may also include (e.g., using a machine learning model) a deployable algorithm for near-instant (e.g., real-time and/or near real-time) determination of base pricing for assets (e.g., any assets) conforming to model guidelines. The exemplary disclosed method may further include determining a final valuation for each asset in the portfolio file that may conform to the valuation model by overlaying variable adjustments received from a business. The exemplary disclosed method may also include displaying or sending to a business the following: data conformance guidelines for available valuation models, asset level valuation results, and/or data visualizations summarizing valuation results. The exemplary disclosed method may also include receiving from a business details describing assets that the business may not buy. The exemplary disclosed method may further include displaying or sending (e.g., to users who have uploaded a portfolio file for valuation and pricing) a summary that includes valuation (e.g., on the entire file population) and/or a summary of a subset available for purchase by at least one available buyer. The exemplary disclosed method may also include displaying a history of valuations performed by the user and allowing the user to update valuations and pricing when market rates change.

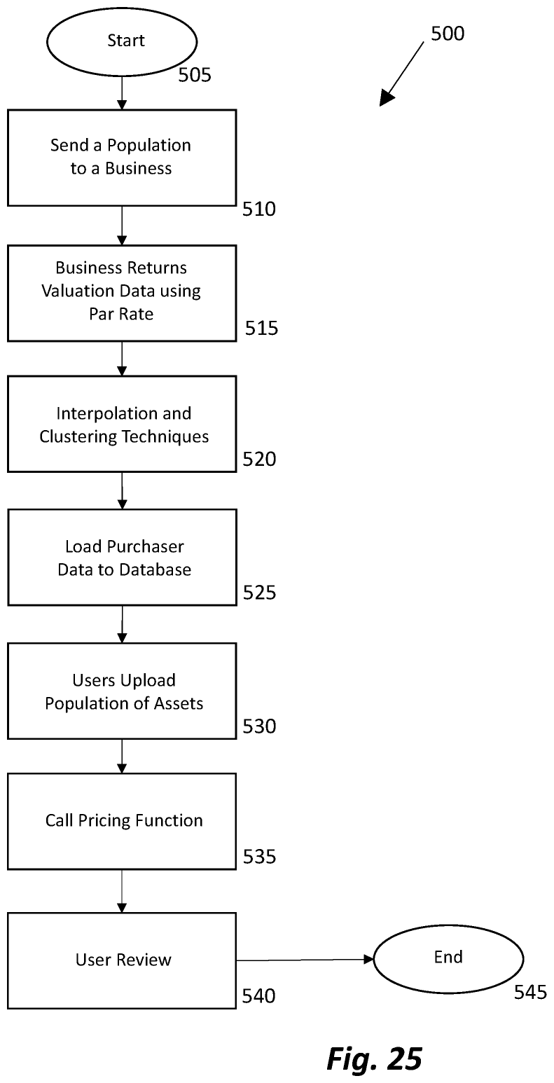

FIG. 25 illustrates an exemplary operation of the exemplary disclosed system (e.g., system 400). Process 500 begins at step 505. At step 510, the exemplary disclosed system may use a full valuation method to provide suitable (e.g., extremely accurate) loan-level valuations. Process 500 may be agnostic as to a type of valuation method used. A business may run a valuation method on a population of assets. A population may be sent to a business, the population reflecting a range (e.g., an exhaustive range) of loan characteristic permutations calibrated to provide the suitable accuracy measured as distance from the same loan valued using a full method. Also for example, a business may perform a valuation on an existing population in its possession.

At step 515, a business may return a population of loans with attached valuation data and a benchmark “par rate” used. In at least some exemplary embodiments, par rate may be a value including one or more published market instrument values specified by the business and combined according to a formula specified by the business.

At step 520, the exemplary disclosed system may analyze the returned population. The exemplary disclosed system may use the exemplary disclosed machine learning operations to derive a set of functions represented in a function data file such that a real asset (e.g., any real asset) with characteristics within the ranges present in the population may be priced in real-time and/or near real-time (e.g., in a fraction of a second) within the user's required tolerance. Using the priced file as-is without analysis may result in significantly more accurate pricing than grids. System 400 may additionally apply a function such that continuous real data may be more accurately priced using interpolation and clustering techniques for example as described herein.

At step 525, the exemplary disclosed system may load the function data file associated with a purchaser to a database for reference by an application. The application may be made available to users (e.g., via the exemplary disclosed user interfaces).

At step 530, user may access the exemplary disclosed system. For example, users may log into a graphical user interface (e.g., similar to the exemplary disclosed user interface) of system 400 and upload a data file population of assets (e.g., assets of the user).

At step 535, the exemplary disclosed system (e.g., system 400) may transform the user asset portfolio file format to conform to a normalized structure. System 400 may call a pricing function that applies the functions of the function data file to the assets in the user file.

At step 540, users may review summary and/or loan level data immediately (e.g., in real-time and/or near real-time) in the exemplary disclosed application using the exemplary disclosed user interface. Also for example, users may download data for immediate (e.g., or later) analysis using systems external to the application (e.g., systems similar to the exemplary disclosed systems of FIGS. 27-29). Process 500 ends at step 545.

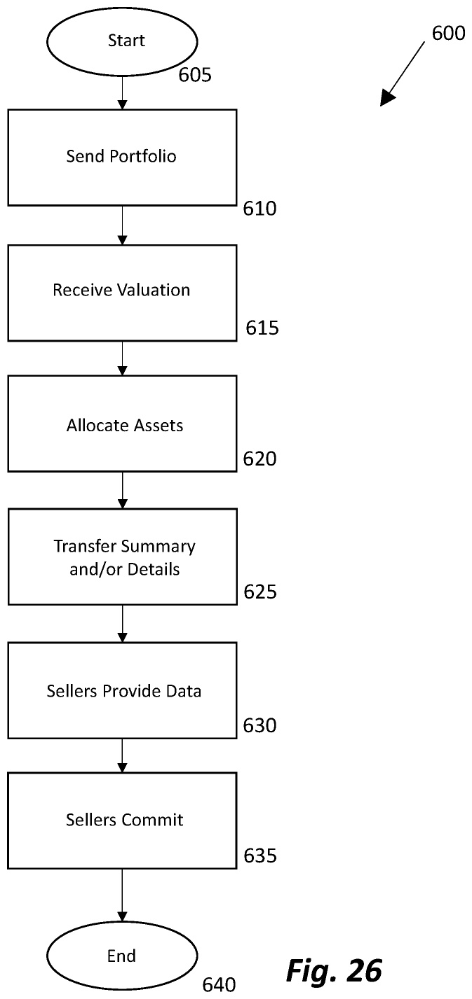

FIG. 26 illustrates an exemplary operation of the exemplary disclosed system (e.g., system 400). Process 600 begins at step 605. At step 610, buyers utilizing the exemplary disclosed system may maintain internal valuation models that may not be shared with other users. Buyers may also maintain pricing based on internal valuations that may be shared with other users. In at least some exemplary embodiments, when buyers wish to respond to an RFQ (e.g., any suitable RFQ) for assets within suitable parameters (e.g., well-defined parameters), the exemplary disclosed valuation method (e.g., described above regarding process 500) may provide a technique for buyers to share a pricing basis associated with the valuation (e.g., with adjustments made for desired returns and appetite for specific collateral features). A business may send a portfolio including its internal valuation. A business may also send adjustments to some or substantially all loans that may for example include static adjustments to base pricing, specific feature adjustments, and/or adjustments that may apply after purchasing a threshold volume in a predetermined timeframe.

At step 615, sellers utilizing the exemplary disclosed system may transfer (e.g., upload) portfolios. The sellers may receive valuations and pricing based on a fair market value of data associated with the subset of buyers and sellers (e.g., those buyers available to those sellers).

At step 620, sellers utilizing the exemplary disclosed system may continue to commit some or substantially all loans eligible to be sold to one or more buyers. The exemplary disclosed system may also allocate (e.g., automatically allocate) each asset to the investor with the highest pricing (e.g., associated with each asset).

At step 625, sellers utilizing the exemplary disclosed system may download a report (e.g., a stratification report) that summarizes the pricing received. The report may group the pricing (e.g., group into features) and may show results at a sub-group level (e.g., displayed via the exemplary disclosed user interface). Also for example, sellers may download the asset level details including valuation and/or pricing results.

At step 630, sellers utilizing the exemplary disclosed system may choose to create a new portfolio. The new portfolio may be based on a subset of the original portfolio. Also for example, sellers may add to the original with other assets and then upload the new portfolio to obtain new pricing.

At step 635, when sellers utilizing the exemplary disclosed system may be ready to commit to the eligible assets, the sellers may enter input to commit via the exemplary disclosed user interface (e.g., sellers may click a commit button and verify that the population data is accurate and that the sellers intend to commit the eligible assets). Entering input to commit may conclude a legal contract. The exemplary disclosed system may output data (e.g., return a message) acknowledging the transaction. Sellers may view details of the transaction via the exemplary disclosed user interface. For example, sellers may return to a review screen (e.g., a tape management screen such as a loan tape management screen) to view the portfolio (e.g., in a history display) as well as review details and/or download stratification reports and/or asset level details. Process 600 ends at step 640.

In at least some exemplary embodiments, the exemplary disclosed system (e.g., system 400 including the exemplary disclosed DPX components) may utilize machine learning to approximate loan-level valuation processes (e.g., relatively quickly approximate the slow but accurate loan-level valuation processes that businesses may use). In order to create this approximation, the exemplary disclosed system (e.g., system 400 including the exemplary disclosed DPX components) may utilize a representative sample of loans covering a range of input characteristics that may have been priced by other loan-level valuation processes that businesses may use. The exemplary disclosed system may select sample loans by exhaustive permutations of input characteristics, non-exhaustive permutations of input characteristics using low discrepancy sequences, and/or randomized selection of existing loan assets. The choice of how to select sample loans may affect a final accuracy of the exemplary disclosed system (e.g., system 400 including the exemplary disclosed DPX components) and/or a number of valued loans suitable for creating a machine learning model. For example, exhaustive permutations of input characteristics may provide suitable (e.g., excellent) accuracy but may involve a relatively high number of loans to be valued before model creation can be initiated by the exemplary disclosed system (e.g., system 400 including the exemplary disclosed DPX components). Non-exhaustive permutations of input characteristics using low discrepancy sequences and/or randomized selection of existing loan assets may provide suitable accuracy with fewer (e.g., significantly fewer) valued loans.

After a representative sample of loans is selected, a plurality of machine learning models having various hyperparameter settings may be fitted and tested by the exemplary disclosed system to determine which model and settings suitably predict (e.g., most accurately predict) other relatively slow but accurate valuation processes that businesses may use. The exemplary disclosed system may test various combinations of machine learning models. The exemplary disclosed system (e.g., system 400 including the exemplary disclosed DPX components) may choose a final model based on accuracy while also maintaining real-time and/or near real-time predictions (e.g., a near-instant time to predict).

The exemplary disclosed system (e.g., system 400 including the exemplary disclosed DPX components) may, as a final step, adjust or exclude predicted values based on input characteristics and/or customer criteria. For example, prices may be lowered by a set spread to provide a base level of profit for investors. Certain regions or characteristics (e.g., relatively low credit scores and/or relatively high debt-to-income) may also be excluded (e.g., excluded automatically) by the exemplary disclosed system so that an investor may not see available loans that do not meet the qualifications of the user (e.g., investor).

The exemplary disclosed system may send a representative example of the data format that may be mapped to a normalized format of the application to sellers (e.g., prior to sellers receiving login credentials). The representative example may allow users to upload data in their own format (e.g., own proprietary format) without conforming to multiple buyer formats. The representative example may also allow users to upload one file and/or receive pricing from multiple buyers (e.g., without any additional steps). The exemplary disclosed system may thereby allow users to upload a file to receive pricing with an option to commit and complete a transaction (e.g., a contract) with simple input (e.g., the click of a graphical button provided by a user interface).

In at least some exemplary embodiments, the exemplary disclosed system and method may automatically provide valuations and/or pricing via a secure, self-service graphical user interface that may allow a user to upload a new portfolio (e.g., at any time) and/or receive updated valuations and pricing in real-time and/or near real-time (e.g., in seconds). The updated valuations and pricing may be driven by dynamic par rates that maybe automated by connection to market data. For example, as opposed to communicating separately with one or more investors in order to coordinate receiving bids on a portfolio, a seller may upload data (e.g., a tape such as a loan tape) to the platform and receive pricing from multiple investors in real-time and/or near real-time (e.g., instantly). The user (e.g., seller) may repeat the exercise as desired (e.g., as market rates change). The exemplary system and method may thereby valuate complex assets, which may be otherwise difficult to value. The exemplary disclosed system and method may provide a self-serve technique (e.g., not involving highly skilled professionals) that a seller may use to acquire a valuation on new portfolios. The exemplary disclosed system and method may provide a technique for acquiring a valuation from a third party in real-time and/or near real-time (e.g., in seconds or minutes). The exemplary disclosed system and method may provide a technique for acquiring a valuation at little or no cost to a seller.

In at least some exemplary embodiments, the exemplary disclosed system and method may not include manual steps such as emailing spreadsheet grids that involve a user determining a way to apply a pricing model to a portfolio. The exemplary disclosed system and method may utilize a pricing model (e.g., consume any pricing model) from any suitable number of investors, which may provide a seller an ability to upload a portfolio file, with suitable models (e.g., all models) being applied automatically. The exemplary disclosed system and method may provide a history of valuations to users via the exemplary disclosed user interface and/or download (e.g., including features for sorting and filtering). The exemplary disclosed system and method may provide an integral organizational system for users for uploading multiple portfolios and/or updating valuations as market rates change.

In at least some exemplary embodiments, reporting may be normalized independently of the buyer's identity, which may provide sellers with valuation and pricing from multiple buyers in the same format, making it easier to consume and compare. Valuations on suitably sized portfolios may be performed using efficient algorithms for extrapolating pricing. For example, suitable accuracy may be achieved with valuations of 5,000 assets or more.

In at least some exemplary embodiments, after a one-time setup (e.g., as illustrated in FIG. 22), the exemplary disclosed system and method may map a seller portfolio format to a normalized format, allowing a user to upload data (e.g., one tape) to the interface and receive valuation and/or pricing from multiple investors. The exemplary disclosed system and method may automatically provide a user with a desired price (e.g., a best price) among the available investors (e.g., without buyers transforming the seller portfolio to their own format prior to pricing).

In at least some exemplary embodiments, a user may be a holder of an asset, and a valuation may be the holder's own valuation model that may be easily and quickly used by suitable users (e.g., anyone in the holder's business) as often as desired with as many tapes (e.g., loan tapes) as desired. The exemplary disclosed system and method may not involve a separate tool or technique for pricing.

In at least some exemplary embodiments, the exemplary disclosed system and method may allow a seller to obtain a valuation and then, if desired, sell that portion of the portfolio eligible for committing (e.g., not excluded by one or more buyers) in real-time and/or near real-time (e.g., immediately) in the same secure login. Sellers may thereby seamlessly perform some or substantially all activities for valuation, pricing, committing, and/or reporting in the same session in the same secure login.

In at least some exemplary embodiments, the exemplary disclosed system and method may provide an ability for users to commit to valuation levels, thereby providing tradable prices, instant liquidity, and/or a reliable measure of fair market value. Cash flow projections generated by the exemplary system and method may be based on real pricing and therefore relatively more reliable.

In at least some exemplary embodiments, the exemplary disclosed system and method may provide for efficient location (e.g., identification) of counterparties by allowing a user to be paired with multiple investors quickly and efficiently (e.g., with little or no additional time or expense used to begin obtaining valuations and pricing from new investors). For example, once an investor has shared pricing with one seller, there may be little or substantially no additional time, expense, and/or effort expended to share pricing with any number of sellers using the exemplary disclosed system and method. Investors may thereby see relatively more product than the investors normally would see, and sellers may obtain pricing from relatively more investors.

In at least some exemplary embodiments, the exemplary disclosed system and method may address the complexity of generating bids for seasoned assets and the effort involved to coordinate receiving bids from multiple investors (e.g., bids solicited as “all or none” when sellers may receive better pricing if they were able to sell some portion of the portfolio to different investors). The exemplary disclosed system and method may automatically return a suitable (e.g., best) price among some or substantially all available investors for each asset. The exemplary disclosed system and method may thereby simplify selling different portions of a portfolio to different investors and/or receiving a relatively higher price for an entire portfolio.

In at least some exemplary embodiments, the exemplary disclosed system and method may include a browser-based application written in python, JavaScript, html, and/or CSS programming languages (e.g., and designed for modern browsers). The exemplary disclosed system and method may include a graphical user interface and/or interfaces for desktop computers, tablets, and/or portable devices. The exemplary disclosed machine learning models may utilize a valuation exercise (e.g., a first valuation exercise) to create a model that may be applied to future assets to return a valuation within a threshold accuracy acceptable to investor criteria (e.g., to effectively avoid adverse selection and/or to avoid failing to provide a suitably competitive price).

In at least some exemplary embodiments, the exemplary disclosed system and method may provide for sharing accurate (e.g., highly accurate) asset-level valuations and pricing in real-time and/or near real-time between users. For example, the exemplary disclosed system and method may provide investors with automated bidding for significantly complex assets such as, for example, seasoned mortgage servicing rights and/or seasoned whole loans.

In at least some exemplary embodiments, the exemplary disclosed system and method may involve relatively low maintenance. For example, buyers may run a valuation on the exemplary closed pricing file once a month. Between monthly valuation activities, the exemplary disclosed system and method may dynamically follow the market by receiving (e.g., consuming) index pricing data from financial data vendors and/or any other suitable source, re-creating each buyer's benchmark “par note rate,” and/or calculating a difference between each loan's note rate and the benchmark as one of the dimensions of the exemplary disclosed pricing function. The exemplary disclosed system and method may track indices intraday (e.g., during the day) and may update par rates at any suitable interval (e.g., every 10 minutes), may not involve multiple buyers performing separate par rate updates daily, and/or may provide sellers with updated pricing for some or substantially all buyers. The exemplary disclosed system and method may address risk for buyers associated with relatively large moves in the market by providing suitably updated par rates. For example, the exemplary disclosed system and method may suitably update index data such as par rates to maintain accuracy within buyer tolerances intraday so that pricing may reliably correspond to (e.g., match) a buyer's valuation and so that buyers may confidently bid their desired price (e.g., true price) rather than reducing their price to allow for market movements.

In at least some exemplary embodiments, the exemplary disclosed system and method may avoid sellers paying money for services prior to getting pricing such as services for writing a function or obtaining a buyer pricing grid. For example, when sellers upload their asset portfolio files to the application, the exemplary system and method may look up a price (e.g., for each loan in a table that the system created when buyers performed valuations ahead of time for example as described above on an exhaustive set of permutations on a specified step value and range for each loan characteristic). Because an original valuation may be performed by the exemplary disclosed system and method on each loan's full set of characteristics rather than using each characteristic independently to adjust the price, each loan may capture (e.g., substantially fully capture) a covarying nature of the loan characteristics. The exemplary disclosed system and method may produce suitably accurate results when pricing new loans with continuous data characteristics. For example as described herein, the exemplary disclosed system and method may utilize interpolation to provide a suitably accurate replication of a full valuation.

In at least some exemplary embodiments, the exemplary disclosed system and method may provide sellers with a graphical user interface for uploading a portfolio file of assets and/or providing pricing and an option to commit in the same login in the same session. The response provided by the exemplary disclosed system and method may be immediate, automatic, or dependent on investor input responses to the system.

In at least some exemplary embodiments, the exemplary disclosed system and method may avoid involving emailing a spreadsheet of adjusters for individual loan collateral characteristics and/or users that may be tasked with writing their own excel-based functions or using another service to price a portfolio of assets. The exemplary disclosed system and method may be a web-based tool that may allow users to log in at any suitable location having internet access, upload their asset portfolio files, and receive pricing in real-time and/or near real-time (e.g., in seconds). Pricing from multiple buyers may be normalized by the system so that sellers may avoid writing multiple functions to obtain pricing from multiple buyers. The exemplary disclosed system and method may communicate updated pricing information in real-time and/or near real-time (e.g., immediately), for example for up to as many buyers with which a given seller using the system may be associated. Sellers may upload a file, and the exemplary disclosed system and method may apply that data to some or all buyers associated with the seller. The exemplary disclosed system and method may include an intuitive user interface for uploading loans, reviewing a summary of the data uploaded to confirm the data is correct, receiving pricing from one or more buyers without any additional effort, editing commit details prior to committing, downloading pricing for external analysis and/or reviewing loan level pricing in the platform, committing assets within a time window, accessing to a history of uploaded (e.g., priced and committed) tapes, and/or receiving real-time and/or near real-time email transaction notifications and periodic reporting (e.g., at zero cost to sellers).

In at least some exemplary embodiments, the exemplary disclosed system and method may utilize the availability (e.g., relatively wide availability) of computing devices, internet access, and/or machine learning libraries to generate and provide valuations and pricing to some or substantially all potential users in real-time and/or near real-time.

In at least some exemplary embodiments, the exemplary disclosed system and method may be used for any suitable complex asset. The exemplary disclosed system and method may be applied to valuation and pricing of seasoned mortgage assets, and to share pricing models with sellers such that sellers may apply that model on their own to any portfolio. The exemplary disclosed system and method may provide an accurate valuation and price for seasoned assets that sellers may apply to any suitable portfolio. The exemplary disclosed system and method may utilize a relatively quick one-time valuation process to achieve a relatively accurate valuation. The exemplary disclosed system and method may be used for any suitable complex asset valuation and pricing including, for example, mortgage loans, mortgage servicing rights, non-QM loans, and/or any other suitable loan and/or assets.

In at least some exemplary embodiments, the exemplary disclosed system may include a mortgage servicing and loan valuation module, comprising computer-executable code stored in non-volatile memory, a processor, and a user interface configured to communicate with the mortgage servicing and loan valuation module and the processor. The mortgage servicing and loan valuation module, the processor, and the user interface may be configured to receive a full loan valuation data of a buyer, select a plurality of loan samples based on the full loan valuation data, determine a function data file based on the full loan valuation data and the plurality of loan samples using machine learning operations, transform a seller asset data of a seller, which includes a plurality of assets, to a normalized data structure, determine a subset of the plurality of assets by applying the function data file to the normalized data structure, and receive a commit data from the seller committing to a purchase of the subset of the plurality of assets by the buyer. Selecting the plurality of loan samples may include at least one selected from the group of performing exhaustive permutations of input characteristics, performing non-exhaustive permutations of input characteristics using low discrepancy sequences, performing randomized selection of existing loan assets, and combinations thereof. Applying the function data file may include using at least one selected from the group of interpolation, clustering techniques, and combinations thereof. Selecting the plurality of loan samples may include at least one selected from the group of performing non-exhaustive permutations of input characteristics using low discrepancy sequences, performing randomized selection of existing loan assets, and combinations thereof. The plurality of assets may include complex mortgage loans. Receiving the commit data from the seller may include the seller committing to and completing the purchase by clicking on a graphical button of the user interface. Using machine learning operations may include using a first valuation exercise to create a model that is applied to the normalized data structure to return a valuation within a threshold accuracy. The exemplary disclosed system may also include receiving index pricing data from financial data vendors intraday. The index pricing data may include par rate data. Receiving index pricing data may include receiving index pricing data between several times per day and every 10 minutes. Determining the subset of the plurality of assets and receiving the commit data from the seller may occur in a same login in a same session of the seller via the user interface. The exemplary disclosed system may further include the seller editing the commit data via the user interface before the commit data is received from the seller. The exemplary disclosed system may also include setting a predetermined time period following determining the subset of the plurality of assets in which to receive the commit data. Pricing of the subset of the plurality of assets may expire at the end of the predetermined time period if the commit data is not received, and the system then logs the seller out of the system. The exemplary disclosed system may also include downloading pricing of the subset of the plurality of assets via the user interface.

In at least some exemplary embodiments, the exemplary disclosed method may include receiving a full loan valuation data of a buyer, selecting a plurality of loan samples based on the full loan valuation data, determining a function data file based on the full loan valuation data and the plurality of loan samples using machine learning operations, transforming a seller asset data of a seller, which includes a plurality of assets, to a normalized data structure, determining a subset of the plurality of assets by applying the function data file to the normalized data structure, and receiving a commit data from the seller, via a user interface, committing to a purchase of the subset of the plurality of assets by the buyer. The exemplary disclosed method may also include displaying pricing of the subset of the plurality of assets via the user interface in real-time or near real-time with determining the subset of the plurality of assets. Applying the function data file may include applying one or more of a plurality of machine learning regression models to the normalized data structure and eliminating all local maxima beyond a preliminary threshold. Applying the function data file may include applying one or more of a plurality of machine learning regression models to the normalized data structure and interpolating on a continuous plane using a regression based on k-nearest neighbors.

In at least some exemplary embodiments, the exemplary disclosed system may include a mortgage servicing and loan valuation module, comprising computer-executable code stored in non-volatile memory, a processor, and a user interface configured to communicate with the mortgage servicing and loan valuation module and the processor. The mortgage servicing and loan valuation module, the processor, and the user interface may be configured to receive a full loan valuation data of a buyer, select a plurality of loan samples based on the full loan valuation data, determine a function data file based on the full loan valuation data and the plurality of loan samples using machine learning operations, receive index pricing data between several times per day and every 10 minutes, transform a seller asset data of a seller, which includes a plurality of assets, to a normalized data structure, determine a subset of the plurality of assets by applying the function data file to the normalized data structure, receive a commit data from the seller committing to a purchase of the subset of the plurality of assets by the buyer, and set a predetermined time period following determining the subset of the plurality of assets in which to receive the commit data. Pricing of the subset of the plurality of assets may expire at the end of the predetermined time period if the commit data is not received.

The exemplary disclosed system and method may be used in any suitable application for reducing an error of mathematical models such as pricing models. For example, the exemplary disclosed system and method may be used in any suitable application for reducing a mean error of pricing models introduced by market fluctuations within one or more time sensitive constraints present or existing during secondary mortgage market transactions. Also for example, the exemplary disclosed system and method may be used in any suitable application for providing efficient analytics and transactions services to loan and mortgage-servicing buyers and sellers.

The exemplary disclosed system and method may provide an efficient and effective technique for reducing a mean error of pricing models for the secondary mortgage market. The exemplary disclosed system and method may thereby improve accuracy of modeling for the secondary mortgage market. The exemplary disclosed system and method may also provide an efficient and effective technique for quickly providing an accurate approximation of asset values.

An illustrative representation of a computing device appropriate for use with embodiments of the system of the present disclosure is shown in FIG. 27. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 28, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 28, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 28, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G, 5G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

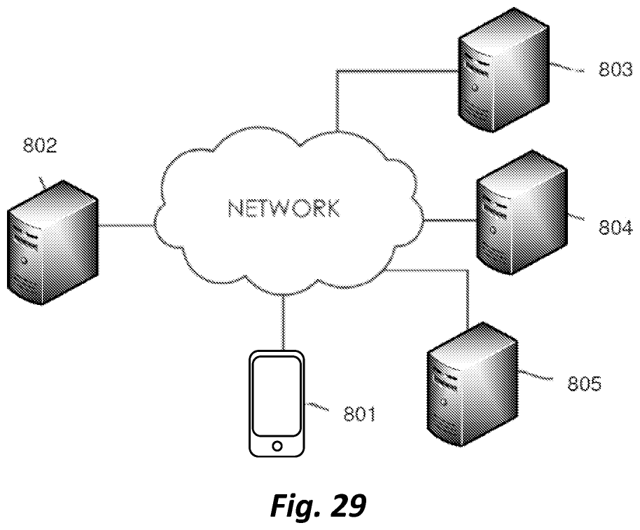

Turning now to FIG. 29, a continued schematic overview of a cloud-based system in accordance with an embodiment of the present invention is shown. In FIG. 29, the cloud-based system is shown as it may interact with users and other third party networks or APIs (e.g., APIs associated with the exemplary disclosed E-Ink displays). For instance, a user of a mobile device 801 may be able to connect to application server 802. Application server 802 may be able to enhance or otherwise provide additional services to the user by requesting and receiving information from one or more of an external content provider API/website or other third party system 803, a constituent data service 804, one or more additional data services 805 or any combination thereof. Additionally, application server 802 may be able to enhance or otherwise provide additional services to an external content provider API/website or other third party system 803, a constituent data service 804, one or more additional data services 805 by providing information to those entities that is stored on a database that is connected to the application server 802. One of ordinary skill in the art would appreciate how accessing one or more third-party systems could augment the ability of the system described herein, and embodiments of the present invention are contemplated for use with any third-party system.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

In at least some exemplary embodiments, the exemplary disclosed system may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

While multiple embodiments are disclosed, still other embodiments of the present disclosure will become apparent to those skilled in the art from this detailed description. There may be aspects of this disclosure that may be practiced without the implementation of some features as they are described. It should be understood that some details have not been described in detail in order to not unnecessarily obscure the focus of the disclosure. The disclosure is capable of myriad modifications in various obvious aspects, all without departing from the spirit and scope of the present disclosure. Accordingly, the drawings and descriptions are to be regarded as illustrative rather than restrictive in nature.

What is claimed is:

1. A system, comprising:
a mortgage servicing and loan valuation module, comprising computer-executable code stored in non-volatile memory;
a processor; and
a user interface configured to communicate with the mortgage servicing and loan valuation module and the processor;
wherein the mortgage servicing and loan valuation module, the processor, and the user interface are configured to:
receive a full loan valuation data of a buyer;
select a plurality of loan samples based on the full loan valuation data;
determine a function data file based on the full loan valuation data and the plurality of loan samples using machine learning operations;
transform a seller asset data of a seller, which includes a plurality of assets, to a normalized data structure;
determine a subset of the plurality of assets by applying the function data file to the normalized data structure; and
receive a commit data from the seller committing to a purchase of the subset of the plurality of assets by the buyer.

2. The system of claim 1, wherein selecting the plurality of loan samples includes at least one selected from the group of performing exhaustive permutations of input characteristics, performing non-exhaustive permutations of input characteristics using low discrepancy sequences, performing randomized selection of existing loan assets, and combinations thereof.

3. The system of claim 1, wherein applying the function data file includes using at least one selected from the group of interpolation, clustering techniques, and combinations thereof.

4. The system of claim 1, wherein selecting the plurality of loan samples includes at least one selected from the group of performing non-exhaustive permutations of input characteristics using low discrepancy sequences, performing randomized selection of existing loan assets, and combinations thereof.

5. The system of claim 1, wherein the plurality of assets includes complex mortgage loans.

6. The system of claim 1, wherein receiving the commit data from the seller includes the seller committing to and completing the purchase by clicking on a graphical button of the user interface.

7. The system of claim 1, wherein using machine learning operations includes using a first valuation exercise to create a model that is applied to the normalized data structure to return a valuation within a threshold accuracy.

8. The system of claim 1, further comprising receiving index pricing data from financial data vendors intraday.

9. The system of claim 8, wherein the index pricing data includes par rate data.

10. The system of claim 8, wherein receiving index pricing data includes receiving index pricing data between several times per day and every 10 minutes.

11. The system of claim 1, wherein determining the subset of the plurality of assets and receiving the commit data from the seller occur in a same login in a same session of the seller via the user interface.

12. The system of claim 1, further comprising the seller editing the commit data via the user interface before the commit data is received from the seller.

13. The system of claim 1, further comprising setting a predetermined time period following determining the subset of the plurality of assets in which to receive the commit data.

14. The system of claim 13, wherein pricing of the subset of the plurality of assets expires at the end of the predetermined time period if the commit data is not received, and the system then logs the seller out of the system.

15. The system of claim 1, further comprising downloading pricing of the subset of the plurality of assets via the user interface.

16. A method, comprising:
receiving a full loan valuation data of a buyer;
selecting a plurality of loan samples based on the full loan valuation data;
determining a function data file based on the full loan valuation data and the plurality of loan samples using machine learning operations;
transforming a seller asset data of a seller, which includes a plurality of assets, to a normalized data structure;
determining a subset of the plurality of assets by applying the function data file to the normalized data structure; and
receiving a commit data from the seller, via a user interface, committing to a purchase of the subset of the plurality of assets by the buyer.

17. The method of claim 16, further comprising displaying pricing of the subset of the plurality of assets via the user interface in real-time or near real-time with determining the subset of the plurality of assets.

18. The method claim 16, wherein applying the function data file includes applying one or more of a plurality of machine learning regression models to the normalized data structure and eliminating all local maxima beyond a preliminary threshold.

19. The method claim 16, wherein applying the function data file includes applying one or more of a plurality of machine learning regression models to the normalized data structure and interpolating on a continuous plane using a regression based on k-nearest neighbors.

20. A system, comprising:
a mortgage servicing and loan valuation module, comprising computer-executable code stored in non-volatile memory;
a processor; and
a user interface configured to communicate with the mortgage servicing and loan valuation module and the processor;
wherein the mortgage servicing and loan valuation module, the processor, and the user interface are configured to:
receive a full loan valuation data of a buyer;
select a plurality of loan samples based on the full loan valuation data;
determine a function data file based on the full loan valuation data and the plurality of loan samples using machine learning operations;
receive index pricing data between several times per day and every 10 minutes;
transform a seller asset data of a seller, which includes a plurality of assets, to a normalized data structure;
determine a subset of the plurality of assets by applying the function data file to the normalized data structure;
receive a commit data from the seller committing to a purchase of the subset of the plurality of assets by the buyer; and
set a predetermined time period following determining the subset of the plurality of assets in which to receive the commit data;
wherein pricing of the subset of the plurality of assets expires at the end of the predetermined time period if the commit data is not received.
